(19) United States
(12) Patent Application Publication
(10) Pub. No.: US 2003/0216971 A1
(43) Pub. Date: Nov. 20, 2003

(54) User interface for a system using digital processors and networks to facilitate, analyze and manage resource consumption

(75) Inventors: Terrence E. Sick, Rochester, NY (US); John Robert Howell, Rochester, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logical Energy Solutions, LLC, W. Henrietta, NY (US)

(21) Appl. No.: 10/386,618

(22) Filed: Mar. 11, 2003

Related U.S. Application Data
(63) Continuation of application No. 09/602,768, filed on Jun. 23, 2000, now abandoned.
(60) Provisional application No. 60/143,846, filed on Jul. 15, 1999.

(51) Int. Cl. G06F 17/60

(52) U.S. Cl. 705/26

(57) ABSTRACT

A user interface for a system for buying and selling resources consumed over time by using a network such as the Internet. The system facilitates the auction of commodities or resources consumed over time, such as energy. Aspects of the system include metering the actual use of the commodity, analysis of time-of-usage patterns, use of the Internet or other network to provide user interfaces and transfer of information, use of customer data such as location, division, billing code, type of usage, modeling of predicted and actual consumption with respect to a chosen plan. The system allows a consumer to acquire, maintain and manipulate usage statistics to allow for more intelligent planning and purchase of the commodity. The system allows a consumer to plan for control of consumption so as to optimize usage patterns such as shutting down non-essential equipment during peak usage hours to stay under certain critical usage parameters to optimize acquisition cost. Information can be downloaded to a computer and evaluated in real time or at a later time in 3rd party applications and analysis tools, such as a spreadsheet application. This provides flexible exploration and manipulation of the information. Existing, traditional, buying and regulatory procedures and rules are taken into account by the system. For example, tariffs and federal and local laws are taken into account. A buyer of resources can create an auction to permit resource suppliers to bid to supply the resource to the buyer.

### CLAIM OF PRIORITY

This application claims priority from U.S. Provisional Patent Application Serial No. 60/143,846 filed Jul. 15, 1999.

### FIELD OF INVENTION

This invention relates in general to the transfer and processing of information in digital processors and networks and more specifically to a system that facilitates selling, purchasing, analyzing and managing resources, and data related to the resources, by using digital processors and networks.

### BACKGROUND OF THE INVENTION

The rise in public acceptance of computers and the Internet has caused many traditional forms of business to be adapted to “online” businesses. Thus, consumers can now purchase a variety of products and services by using their computers at home, the office, from a hotel room, or virtually anywhere. However, the extent that traditional online businesses (also called electronic commerce or “e-commerce”) can provide products and services for sale is very basic.

For example, physical goods can be sold rather easily online as long as the goods are known commodities. A book, video tape recording, audio compact disc, etc., are examples of items that consumers feel comfortable about purchasing online because there is little variation among each item and because there is no value in differences among items. However, other items such as clothing, automobiles or services such as plumbing are more difficult to identify from a computer interface. Typically, a user is provided with a picture and text description of the goods and must decide simply whether to make the purchase at the advertised price, or not. Naturally, such an online purchasing model is insufficient to allow consumers to intelligently purchase more complex items or services, or to consumers feel confident that they have obtained the desired goods at a reasonably competitive price.

Another aspect of online commerce is that the purchasing model has become diverse. Not only are massive online auctions of goods possible, but “reverse auctions” (where a buyer names how much they wish to spend on an item and a seller decides whether to sell at that price) and other variations are possible via different levels of complexity. Not only are many purchasers unfamiliar with these types of purchasing models, but the overall complexity of computer systems and online access creates a “fear factor” that can prevent consumers (also referred to as “customers” or “users”) from using online purchasing to fulfill many of their consumer needs.

For example, one area of consumerism that is high in complexity is the procurement of goods, or resources, over a period of time. That is, unlike the simple single-instance purchase of an item, the contracting, or negotiation, for the purchase of resources over time is unfamiliar territory to most public consumers. For this reason, the purchase of resources over time has not been open to negotiation in the traditional consumer model for such goods and services. For example, utility bills for power, telephone use, cable television, etc., are an ongoing expense to consumers. However, the companies providing such resources over time single-handedly compute the cost to the consumer. The consumer has enjoyed very little choice in where to obtain such resources and, where a choice is available (e.g., among two different cable television providers) even the small amount of variables (number of television stations available, periodic and fixed costs, hardware costs, etc.) are overwhelming for most consumers.

On the other hand, it is desirable to provide consumers with an online system that allows more efficient study, procurement and management of resources delivered over time. In this way consumers can enjoy the benefits of online purchasing such as automatic record keeping, customization and price comparing. Suppliers, or sellers, can similarly benefit by automating their functions of accounting, sales, support, distribution and monitoring.

In order to realize optimization of the free market for complex time-variant resource purchases, users need to fully understand, manage, aggregate, and, where appropriate, disaggregate their energy usage and present it to suppliers and distributors. There are, however, many impediments to this. For one thing, users are often not currently in possession of detailed information on their usage as to how it affects the amount, time of day, seasonality, and relationship to peak usage, or consumption. The relationship of an organization's or individual's energy usage to the current energy pricing metrics and those that emerge as the market evolves into more complex pricing schemas and presentation changes need to be understood and massaged to enable pricing optimization, and to enable taking full advantage of electronic bidding and auctions.

The nature of time-dependent resource market pricing is unique in that providers sometimes set prices by various classes of usage. Over time the unique and complex nature of this pricing has been developed by the various industries, and, to some extent, favors these industries over the consumers. The trends of deregulation and technology promises to change this market and the manner in which it functions dramatically. Systems and methods that can empower users to take full advantage of the market potential will be a public benefit.

### SUMMARY OF THE INVENTION

The invention provides a series of modules and approaches that enables a new market and a new business model. Network-based communication issued for collection, analysis, combination, comparison, iteration, bid, comparison and analysis of bids, and execution of buy the users of the system of the present invention can range from individual consumers to massive industrial manufacturing complexes with varied usage and types of energy consumption. Usage patterns can be combined with the energy requirements of one or more additional complexes, or segments of additional complexes, so that in a given city or region or even across a nation, the usage of energy consumers (be they industrial, residential, governmental, for-profit, not-for-profit, etc.) can be collected, analyzed, combined, sub-divided, iterated, pooled, and presented for review by a group of energy suppliers. The suppliers can analyze and compare the presented energy usage pattern profiles of the groups and aggregated combinations, consider their energy supply and pricing costing and options, and present to the buying organization, or pool, an overall price with as many caveats, special terms and conditions, variances, peak consumption parameters and rules, as they feel appropriate. Both the buyer and the seller in this new energy market will have both a technical and an analytical means to compare the complex combinatorial user requirement with the complex , combinatorial bid.

Although the specific application of the invention to power or energy purchases is discussed in detail in this specification, it should be apparent that the invention can be applied to any time-based procurement of resources or goods. That is, where the consumer's and supplier's obligations are ongoing for a period of time so that continuous or intermittent delivery of a product or service is provided, such a procurement can benefit from the application of the present invention.

The concept of a low bid energy auction differs from the many other traditional types of auctions one encounters in that the buyer here sets out their usage through a methodology that enables the creation of a usage profile that can electronically convey and support the combinations of usage patterns, that is types and classes of energy consumptions of any given commodity to an electronic auction metaphor that then allows the bidders to examine, analyze and iterate the patterns of usage, compare these to their costs, availabilities, rate structure variances, etc., and then provide a common means of stating their overall aggregate and lowest or best bid offer. Unlike an auction of things, or airline tickets, or teddy bears, the system handles complex patterns of usage that may change with the time of the day, the day of the week, the week of the month, the month of the year, and consumption within arbitrarily created bands and classes of usage that may vary infinitely. While the user provides an overview of historical and/or predicted usage, actual usage will vary, and conversely, while the bidder provides a price, it usually comes in ranges. So much for this much usage within this class of usage within this timeslices, but that much more if you go over x during period y.

We have devised a means to help the energy consumer or consumer group aggregate this, analyze it, attempt to optimize it by management, scheduling, alternative usage patterns, invocation of on-site energy alternatives such as power generation, etc., conservation, relocation, and then present this optimal combination of requirements, alternative requirements, to the auction where the bidders can then examine these complex profiles and effectively do the reverse analysis and mating of energy supply. It is envisioned in this system that intermediaries can play an important role in the auction process by providing the optimal combinations of aggregated supplier combinations, leading to an ever more efficient market.

The buyer, once presented with this bid, often consisting of many variables and caveats, may first wish to explore the implications of the bid in the face of the potential for usage pattern variances, and determine the overall best cost and value. These are often iterative and subjective measures that require human analytics and intervention throughout the process. We have provided for this, and provide a framework for the ongoing tuning and refinement of this low bid energy auction that allows for significant flexibility over time. The user, by subdividing their energy consumption into finer granularities, as taught herein, and by keeping track of this usage so it can be reviewed, iterated and analyzed, takes a major step forward into enabling themselves to take advantage of this new world. The bidder likewise enables entry into this new market by adapting as much understanding and analysis and flexibility and automation as possible in attacking this market.

The present invention provides a low bid energy auction for energy commodities, particularly when taking into account the customer's historical usage patterns and using those in an energy profile, as taught herein, to facilitate a low bid energy auction over the Internet or other network.

There is a need for the technological means to collect, store, analyze, organize, iterate, and optimize energy usage patterns and prepare them electronically for optimal presentation against the complex and varied offerings of the energy market. There is conversely a need for the energy suppliers and intermediate distributors to analyze the usage patterns of customers, individually and in aggregate, so as to both obtain from the energy grid and suppliers thereof, and then offer to their customer base, competitive and profitable pricing models.

Further, the nature of the complex usage patterns that exist within the varied facilities, industrial operations and other energy users as they are analyzed and aggregated requires a new type of electronic auction designed for the unique attributes of energy usage, supply and demand.

The present invention uses computers and networks to assist in the collection and organization of energy usage by timeframe and physical location to enable iteration, reconfiguration, visualization, subgroup classification, load balancing, and other approaches to optimize usage and lower cost, and to support the creation of energy auctions that can be conducted over networks to optimize a free energy market.

This invention provides the technical means and know-how to enable an organization to organize its energy use. The usage can be organized in creative ways such as grouping by geographical location, time and patterns of usage, divisional structuring and class of end use such as manufacturing process, heating, cooling, etc. Also, the usage can be organized to iterate possible clusters, groupings, reroutings, off-line power generators for off-line power generation, and other usage possibilities, both manually and automatically, so as to discover and present for purchase and alternative purchasing possibilities and alternative supply possibilities.

The present invention is efficiently handles groups of users with similar energy needs. The groups can have complex energy use requirements. Multiple “bidders” or suppliers of energy are presented with the bids and can choose which bids to fill. The process of matching an energy bid with a supplier is performed optimally by the system. One problem in producing a system with these features is that energy usage patterns can vary widely from historical and predicted patterns. Highly unpredictable weather patterns such as a heat spell or a blizzard can result in large swings that deviate from historical norms. Energy use can vary with other factors, also. Recovery from any number of possible anomalies may put users into new and more complex cost structures resulting in severe and lasting penalties paid under a predefined arrangement, or bid. The sophisticated energy buyer, particularly those dealing with large processing plants and factories have variable schedules and multiple shifts and have large complex systems to analyze, model and present to the market. The supply side has another complex problem of dealing with their energy commodities and pricing them for an optimal market and taking into consideration overall supply limits, hedges, spot market costs, minimum commitments, etc., throughout the period of time represented by the bid and over time the combination of bids.

The invention creates, and also takes advantage of, emerging electronic auctions and alternative methods of pooling and presenting energy usage within an organization, across an organization, or between multiple organizations, in order to take advantage of computers, networks, telemetry equipment and the emergence of computer assisted auctions to optimize cost and usage for any organization or subsegment or group aggregation of any type.

The invention preserves a record of energy usage patterns and types of usage in timeslices, and subsections that facilitate alternative usage analysis and comparison of new pricing methods and opportunities on an ongoing basis. Then, to take that record and identify alternative approaches that may yield cost savings and alternative usage and supplier opportunities and open up alternative opportunities such as local power generation augmentation of primary supplier energy flows, establishing a local generation capability which can manage usage below peak usage patterns and load balance within an organization or facility.

The invention provides a means for multiple sites, divisions, organizations, and groups of organizations, to combine their power usage statistics, timeslices, patterns of usage, load balancing options, and other data in a combinatorial way, by first providing a common data analysis format and providing means and methods for aggregation, segmentation, reorganization, time shifting, and other analytical approaches, and comparing these in an automated and also analytical assisted review of options, alternatives, and flexibilities among suppliers of energy.

The invention provides computer aided analysis, to finding the optimal buying alternative given one or more energy suppliers in a free, regulated or unregulated market. And to seek out, and automatically acquire, the optimal energy supplies possible in real-time, in any given situation and to consider alternatives to these optimal situations.

The invention enables suppliers of energy to aggregate their energy requirements, peak usage patterns, combined energy sources and pricing plans and to compare these electronically to assist analysts in reviewing the data in order to identify and implement optimal pricing and profit possibilities in supplying multiple customers, sites, divisions by time-of-day, season, and other combinations of energy usage data and demand.

The invention takes advantage of the availability of networks, including the Internet, power grid networks, wireless networks, communicating power meters, telemetry, data storage, machine control, and other technological advances and developments to combine alternative management options and alternative buying opportunities, including inclusion of the aforesaid capabilities in automatic or semi-automatic auctions of energy where the combinatorial usage statistics can be used to identify and secure the optimal overall energy supplier contracts and where suppliers can use any of the aforementioned and other capabilities to also identify optimal and most profitable supply and acquisition combinations to optimize for each constituent in the market and for the market overall the analysis, selling and buying and usage of energy.

The invention provides methods and processes for the data acquisition and analysis of energy information and the procurement of energy contracts by conducting a low bid energy auction and implementing load aggregation techniques for the single and/or group purchasing of energy for one and/or multiple energy consumers over an electronic network, and to provide a data collection system incorporating one or more of the following elements: energy metering, time of usage patterns in increments of any size, network or wireless connectivity, sector identification and hierarchical data such as location, division, budget center, cost center, billing code, type of usage, etc., historical supplier, and storage of said collection to allow iterative combinations and recombinations of these data to offer exploration, visualization, iteration, optimization, what-if scenario analysis, and other manipulation of the data to record, understand, analyze and create bids for the acquisition of energy.

The invention enables energy consumers to track in real-time multiple fuel pricing models allowing for immediate switching of alternate energy sources based on price, time-of-use energy patterns, and combinatorial and analytical comparisons of energy, resulting in optimal operating costs.

The invention provides a means for an energy consumer to maintain and manipulate their own energy usage statistics, in part freeing their dependency and expense from acquiring this data from their local utility company or energy provider, who often charge expensive fees for providing this usage information, and to provide enhanced combinatorial and analytical comparisons using the acquired data, and to allow for network connectivity of energy measuring devices; and to allow for control of energy consuming devices, so as to optimize usage patterns such as shutting down non-essential equipment during peak usage hours to stay under certain critical usage parameters as may optimize acquisition cost.

The invention describes means to acquire, store, and aggregate energy usage data ordinarily not stored, or when stored, stored onboard the metering device or usage system, to enable the information to be downloaded to a computer and evaluated in real time or at a later time in any 3rd party spreadsheet application or other analytical tool.

The invention enables the exploration, manipulation, adaptation and presentation of information, and decision support systems both semi-automated and automated, which can enable the exploration of the information for optimal usage and procurement opportunities under the existing buying and regulatory parameters and to enable rapid analysis of any changes on state of the tariff and regulatory or other conforming influences on procurement norms as they may change over time.

The invention takes advantage of new capabilities brought about by intelligent metering and machine control capabilities such as Jini technology from Sun Microsystems, which enables users to share services and resources over a network, provide users easy access to resources and energy information anywhere on a network while allowing a network location of the user to change, and simplify the task of building, maintaining, and altering a network of devices, software and users.

Jini will allow for device level intelligence and embedded control and telemetry capabilities in power systems, meters, and at energy consuming devices and systems, allowing these devices to execute actions at certain times and in response to certain conditions which can be configured, programmed and modified as needed to change the nature of the devices on the network, thus creating an intelligent network whose operations are organized and optimized for reporting, network administration, cross platform independence (i.e., common computing platform) to optimize opportunities in the energy market, whether regulated or deregulated.

The invention facilitates the ability of direct connectivity to provide customer and supplier access to real time energy information and critical device performance parameters to enable direct connectivity to reduce the need for dialup ordinarily required to poll and communicate with sensing devices; and to reduce network installation costs by eliminating the need for systems such as RS 232/485 converters, phone modems, radio transceivers, etc.

The invention allows onboard meter intelligence for direct connectivity to process and Heating, Ventilating, and Air Conditioning (HVAC) control systems to regulate, control and optimize equipment operations and energy usage for optimal cost benefits.

This invention teaches a method for computer and network intermediated energy analysis and energy auctions with the steps of a data collection system incorporating one or more of the following elements: energy metering, time of usage patterns in increments of any size, network or wireless connectivity, sector identification and hierarchical data such as location, division, billing code, type of usage, etc., historical supplier, and storage of the collection to allow iterative combinations and recombinations of these data to offer exploration, visualization, iteration, optimization, what-if scenario analysis, and other manipulation of the data to record, understand, analyze and create bids for the acquisition of energy, and to provide enhanced combinatorial and analytical comparisons using the acquired data, to allow for network connectivity of energy measuring devices, to allow for control of energy consuming devices, so as to optimize usage patterns such as shutting down non-essential equipment during peak usage hours to stay under certain critical usage parameters as may optimize acquisition cost, to acquire, store, and aggregate energy usage data ordinarily not stored, or when stored, stored onboard the metering device or usage system, to enable the information to be downloaded to a computer and evaluated in real time or at a later time.

The invention provides an automated or semi-automated method of collecting, analyzing, grouping, reorganizing, optimizing, and procuring energy usage data for optimizing energy use and acquisition costing to facilitate a low bid energy auction.

The invention assists in the collection and organizing of energy usage by timeframe and physical location to enable iteration, reconfiguration, visualization, subgroup classification, load balancing, and other approaches to optimize usage and lower cost.

The invention provides methods and processes for the data acquisition and analysis of energy information and the procurement of energy contracts by conducting a low bid energy auction and implementing load aggregation techniques for the group purchasing of energy for multiple energy consumers over an electronic network.

Other advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

FIG. 1 illustrates the Energy Information System Network Architecture;

FIG. 2 illustrates the Database Architecture;

FIG. 3 illustrates a Wold Wide Web interface;

FIG. 4 is a flowchart showing basic steps in a process for A Rate Designer;

FIG. 5 is a flowchart showing steps in Display Energy Profile;

FIG. 6 is a flowchart showing steps in process to Generate A Utility Bill;

FIG. 7 is a flowchart showing steps in Rate Analysis;

FIG. 8 is flowchart showing Request For Proposal;

FIG. 9 is a flowchart showing Reconcile Utility Bill;

FIG. 10 is a flowchart showing Missing Data Validation;

FIG. 11 is a flowchart showing Create/Edit Expression;

FIG. 12 is a flowchart showing an Auction Process;

FIG. 13 is a flowchart showing Buyer Registration;

FIG. 14 is a flowchart showing Request for Proposal;

FIG. 15 is flowchart showing Create Aggregation Group;

FIG. 16 is a flowchart showing Create Energy Auction;

FIG. 17 is flowchart showing Buyer Auction View;

FIG. 18 is a flowchart showing Supplier Registration;

FIG. 19 is a flowchart showing Browse Auction/Post Bid;

FIG. 20 is flowchart showing Supplier Auction View;

FIG. 21A illustrates a computer system suitable for use with the present invention;

FIG. 21B illustrates subsystems that might typically be found in a computer such as the computer illustrated in FIG. 21A;

FIG. 22A is a first user interface screen picture;

FIG. 22B is a second user interface screen picture;

FIG. 22C is a third user interface screen picture;

FIG. 22D is a fourth user interface screen picture;

FIG. 22E is a fifth user interface screen picture;

FIG. 22F is a sixth user interface screen picture;

FIG. 23A is a seventh user interface screen picture;

FIG. 23B is a eighth user interface screen picture;

FIG. 24A is a ninth user interface screen picture;

FIG. 25A is a tenth user interface screen picture;

FIG. 25B is a eleventh user interface screen picture;

FIG. 25C is a twelfth user interface screen picture;

FIG. 26A is a thirteenth user interface screen picture;

FIG. 26B is a fourteenth user interface screen picture;

FIG. 26C is a fifteenth user interface screen picture;

FIG. 26D is a sixteenth user interface screen picture;

FIG. 27A is a seventeenth user interface screen picture;

FIG. 27B is a eighteenth user interface screen picture;

FIG. 27C is a nineteenth user interface screen picture;

FIG. 27D is a twentieth user interface screen picture;

FIG. 27E is a twenty-first user interface screen picture;

FIG. 27F is a twenty-second user interface screen picture;

FIG. 27G is a twenty-third user interface screen picture;

FIG. 27H is a twenty-fourth user interface screen picture;

FIG. 27I is a twenty-fifth user interface screen picture;

FIG. 27J is a twenty-sixth user interface screen picture;

FIG. 27K is a twenty-seventh user interface screen picture;

FIG. 27L is a twenty-eighth user interface screen picture; and

FIG. 27M is a twenty-ninth user interface screen picture.

### DESCRIPTION OF THE SPECIFIC EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A. Energy Information System Network Architecture

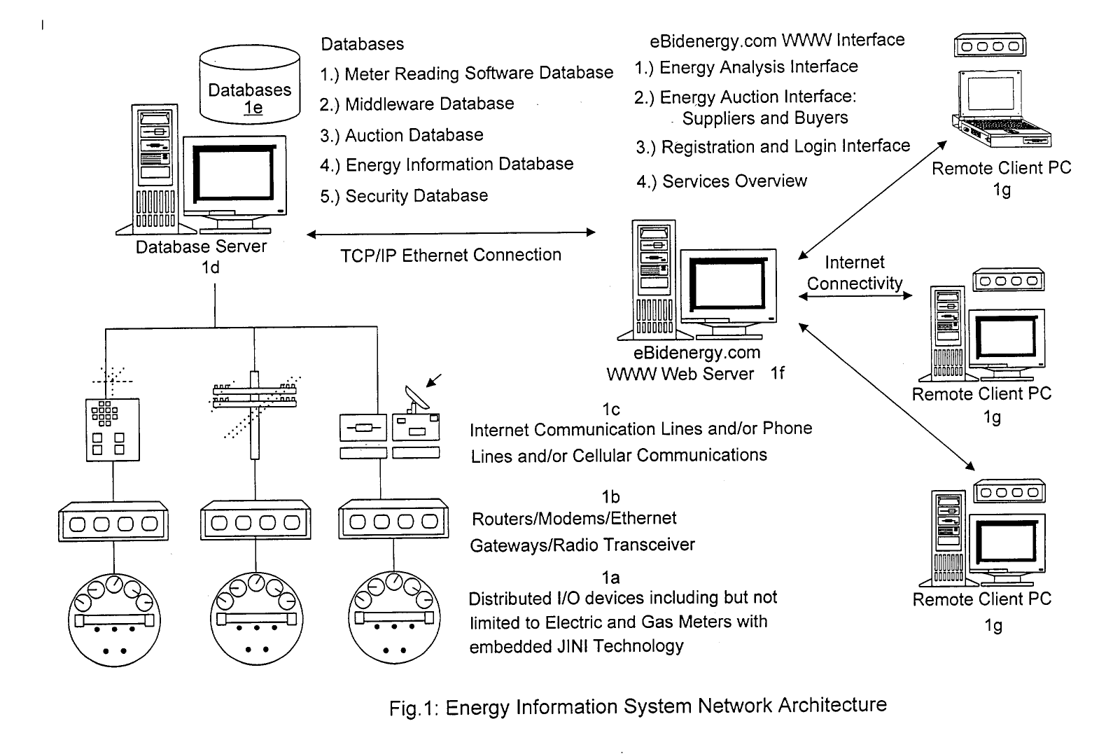

FIG. 1 illustrates the Energy Information System Network Architecture.

In FIG. 1, input/output (I/O) devices 1a include power meters and a combination of localized or distributed I/O devices. I/O devices convert analog and digital sensor waveforms into meaningful engineering values that can be used for monitoring multiple HVAC and process control parameters. These metering devices and sensors are placed at the customer location to dynamically log electrical energy demand and consumption, natural gas, chilled water, steam, compressed air, temperatures, pressures, and flow. These devices can be networked together in a daisy chain configuration with an unlimited number of devices and customers, and by any means of network connectivity, Intranet, Internet, wireless, power line telemetry, etc. FIG. 1 represents the fundamental starting point of any Energy Information Network (EIN). NOTE: Newer methods of Network communications and device level intelligence are developing rapidly.

A preferred embodiment of the invention uses software and hardware technology for sharing services and resources over a network referred to as “Jini,” created and distributed by Sun Microsystems. This is indicated in FIG. 1 where I/O devices la are described. However, any suitable telemetry or I/O mechanisms can be employed.

Some advantages of using Jini technology are that Jini is JAVA-based and is therefore portable and widely supported. The Jini technology also allows for on board memory and intelligence at the sensing device. Further, direct Ethernet connectivity is provided over the Internet or any other type of network. Direct connectivity allows customers and suppliers to access real time energy information and critical device performance parameters. No computer dialup connection via a telephone is required in order to poll sensing devices.

Additional features provided by using a technology such as Jini include reduced network installation costs and system administration costs. The need for RS 232/485 converters, phone modems, radio transceivers, etc., is eliminated. Onboard meter intelligence allows for direct connectivity to process control and HVAC equipment controllers, resulting in dynamic and intelligent load management. Jini agents can also be installed in process controllers and HVAC controllers allowing for more precise and intelligent control, to streamline network administration, reduce data acquisition costs, cross platform independence and overall reduced cost for connectivity. For further details on Jini technology see, e.g., www.jini.org.

World Wide Web (WWW) Server If is used to transfer information between database server 1d and remote client computers 1g. WWW Server If communicates with database server 1d via an Ethernet TCP/IP connection. Other devices and software for facilitating network communications may be employed.

In FIG. 1 database handler 1d includes database server 1e which sends and receives sensor information from remote devices. Devices are currently identified on the network using meter reading software allowing users to define network communication parameters and device configuration parameters. The software architecture contains an underlying ODBC-compliant Microsoft SQL Server database allowing for platform-independent data transfer but nay operate with any ODBC compliant database. In a preferred embodiment, database server 1d runs SQL 7.0 database server software by Microsoft and hosts additional databases each serving specific functions.

Database Architecture

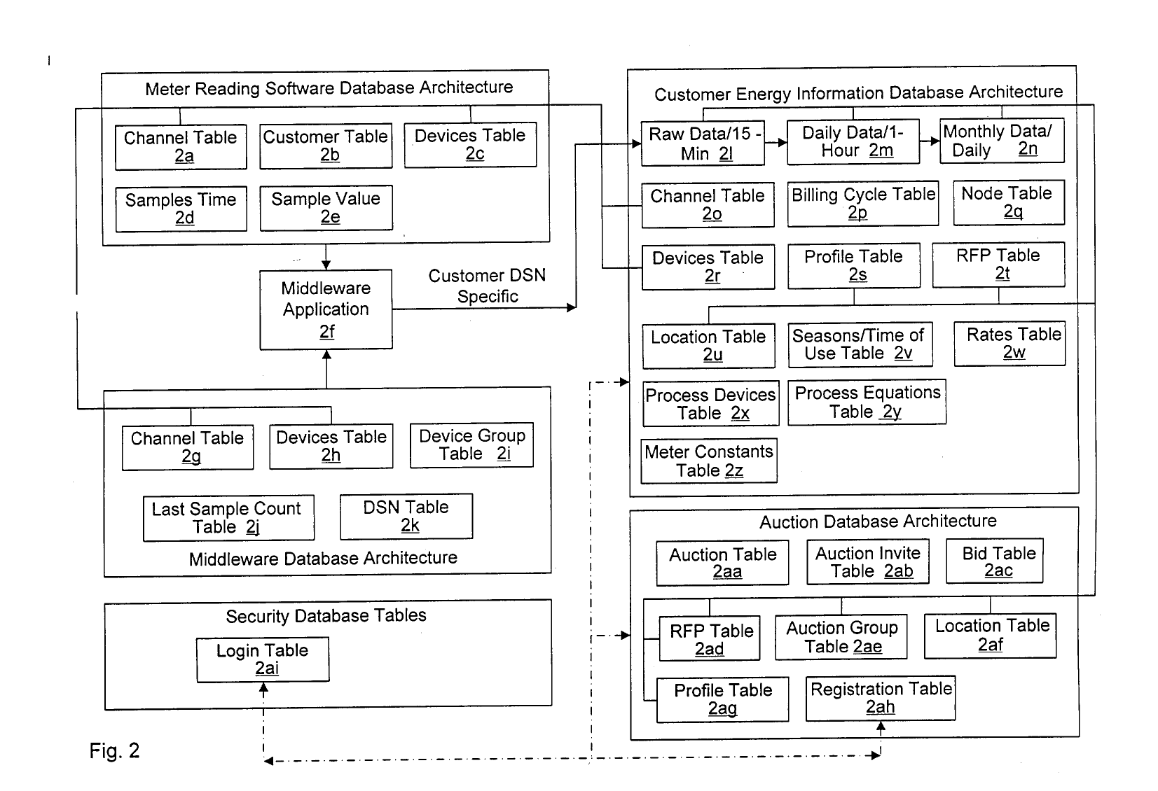

Database server 1d hosts databases and executable software such as the Meter Reading Software Database, the Middleware Application, the Middleware Database, the Customer Energy Information Database, the Energy Auction Database and the Security Database all of which are illustrated in FIG. 2

Metering Reading Software Database Architecture The Meter Reading Software Database holds all energy information for all customers. The Meter Reading Software database includes a Master Channel table 2a which stores information regarding the energy quantities being recorded. Channels can be assigned randomly at the user's discretion. (i.e., Channel 1=kW, Channel 2=kWh, Channel 3=Therrns, etc). The Master Channel table is linked across several databases. The Customer table 2b is used to store limited demographic information about the customer in order to relate a customer ID to a sensor ID. The Device table 2c stores sensor information and is linked across several databases (i.e., meter/sensor ID, meter/sensor description, etc.). The Sample Time table 2d records the date and time of a particular energy value along with an associated sample ID. The Sample Value table 2e stores the recorded value along with channel ID and sample ID.

Middleware Application

Middleware Application 2f is a binary executable software program developed by Logical Energy Solutions that is used to summarize and parse data logged into the meter reading software database into the appropriate customer specific database.

Middleware Application Database Architecture

The Middleware application is tightly integrated between the Meter Reading software database and the Middleware Database. The Middleware database includes a channel table 2g and devices table 2h that are linked to the Meter Reading Software Database channel table 2a and device table 2c. The Devices Groups table 2i stores a group ID to all meters that are associated with a particular customer. For example if the meter reading software is configured to read 20 meters, and 10 belonged to Customer A and 10 belonged to customer B, then there would be a Group ID assigned to Customer A meters and a Group ID assigned to Customer B meters. The Data Source Name (DSN) table 2k is used to store the Open Database Connectivity (ODBC) DSN which instructs the middleware application on which customer energy information database to summarize the data into. Utilizing ODBC DSN's ensures that the customers energy information resides in a secure environment and cannot be viewed by unauthorized users.

Customer Energy Information Database

Customer Energy Information Database includes Raw Data 21 which includes 15-Minute interval energy information, Daily Data table 2m which includes1-Hour interval energy information and Monthly energy data table 2n. These tables store real time and historical interval energy data (e.g., kW, kWh, Tons & TonHrs chilled water, Mlbs steam, Therms natural gas, SCFM compressed air), retrieved from remote field devices at the designated intervals. This information can be used to analyze building, process, and device performance profiles. Profiles being graphical representations of demand and usage as a function of time.

Channel table 2o stores information regarding the energy quantities being recorded. Channels can be assigned randomly at the users discretion (i.e., Channel 1=kW, Channel 2=kWh, Channel 3=Therms, etc). Channel table 2o is linked across several databases.

Billing cycle table 2p stores fixed monthly time periods that coincide with a utility billing cycle. Billing cycles can be customer defined and specific to their own utility service territory.

Node Table 2q stores corporation processes and device information which is then used to build a site map. A site map is required in order to define which meters rollup to a building and/or process, which buildings/processes rollup to a division and which divisions rollup to a corporation. In addition the node table defines how co-incident metering is calculated for billing and aggregation purposes. Coincident metering is used to cut the average cost for power at facilities with many different accounts held by one customer. For example ABC Corporation has several accounts on one property. Each account peaked at different times, but due to rate construction the sum of the bills was the same as though all buildings had peaked at the same time. By combining the accounts under one master demand meter, the average cost of power can be reduced by 10% or more. See example site map below:

ABC Corporation

Building 1
Meter 1
Meter 2
Building 2
Meter 3
Meter 4

Device Table 2r stores sensor information and is linked across several databases, Metering Reading Software Database, and Middleware Database.

Profile table 2s stores a user defined profile for the purpose of linking to auction. The profile table presents a graphical display of energy information that a supplier views prior to placing a bid.

Request for Proposal Table 2t stores a customer's specific terms and conditions. The customer can specify such terms and conditions when seeking energy suppliers. Each customer can have unique requirements relating to energy procurement. This table stores these specific requirements and can be retrieved by suppliers when a customer's energy profile is up for bid in an energy auction. These requirements are defined as Term of Contract (i.e., 12 months, 6 months, spot, etc.), Strike Price (i.e., highest price a consumer is willing to pay), Title Transfer (i.e., State in which consumer desires to take ownership of commodity), Pricing (i.e., City Gate, All Up and In, otherwise known as price at the burner tip), balancing requirements and responsibilities (i.e., daily, monthly, and who, etc.). These requirements will be available to energy suppliers during an active energy auction.

Location Information table 2u stores location specific information for customers that have multiple locations. Location table includes location name, service address, meter number, utility account numbers, supplier account numbers, facility size, annual energy bills, contact name, LDC company name and account number, information regarding existing energy contracts and utility service rate classification. When an auction is completed customer information is provided to the supplier and supplier information is provided to the customer. Customer information is provided to the supplier for delivery purposes. This information is used in the energy auction procedure discussed below.

Seasons/Time of Use table 2v stores information specific to creating a rate plan. Some utility companies charge customers a specific rate based on the time of year and/or time of day when energy is used. Seasons are defined as Spring, Summer, Winter, and Fall. The months of a season may vary depending on geographic location. Time of day periods may be defined as Peak, Mid-Peak and Off-Peak. Hours defining these time periods may also vary based on geographic location.

Rates table 2w stores specific information relative to the type of rate the user wishes to create. Utility tariffs are based on published utility rates and typically are made up of simple rate structures and complex rate structures. Simple rate tariffs are defined as a flat rate for all seasons and time periods. Complex rates take into account seasonal and time of day schedules, seasonal and time of day energy pricing, seasonal and time of day energy blocks, seasonal and time of day demand blocks, declining blocks, mixed blocks, and compound block pricing and schedules. Custom defined utility rates allow users to implement internal billing strategies, evaluate energy profiles as compared to alternate tariffs (i.e., what-if analysis), and optimize load management strategies.

Process Devices table 2x stores information on devices that algebraically sum to a totalized value. For example a customer location has three buildings, each having 1 meter. Meter A, Meter B, Meter C. To arrive at the total location energy consumption, a process equation must be defined. In this example A+B+C=the location total. The process devices table stores the device ID, Equation ID and Channel ID.

Process Equations table 2y stores the Equation ID, Process Equation and Channel ID.

Meter Constants table 2z stores values for the purpose of scaling pulse count values into meaningful engineering units, which can be presented to the user in graphical display as a totalized value.

Auction Database—Buyers and Suppliers

Auction Database is the fourth major database component of database server 1d. Encompassed by this database are several tables including Auction Table 2aa, which contains all current auctions and expired auctions.

Auction Invite Table 2ab stores information on suppliers that have been selected to participate in an auction.

Bid Table 2ac stores dynamic bids while an auction is in progress. In addition to bid amounts, this table stores a supplier's minimum bid during an active auction. If competing suppliers underbid said suppliers minimum bid, supplier is removed from auction and notified of losing the bid with an option to re-enter auction if desired. The bid table also stores the winning bid and/or bids of the successful supplier upon completion of the auction. All final bids in the table are evaluated based on the lowest, most competitive bid.

RFP table 2ad is linked and joined from customer energy information database 5i. This table includes data to allow energy suppliers to evaluate group and individual customer RFP requirements. Request for Proposal Table 5i stores a customer's specific terms and conditions. The customer can specify such terms and conditions when seeking energy suppliers. Each customer can have unique requirements relating to energy procurement. This table stores these specific requirements and can be retrieved by suppliers when a customer's energy profile is up for bid in an energy auction. These requirements are defined as Term of Contract (i.e., 12 months, 6 months, spot, etc.), Strike Price (i.e., highest price a consumer is willing to pay), Title Transfer (i.e., State in which consumer desires to take ownership of commodity), Pricing (i.e., City Gate, All Up and In, otherwise known as price at the burner tip), balancing requirements and responsibilities (i.e., daily, monthly, and who, etc.). These requirements will be available to energy suppliers during an active energy auction.

Auction Group Table 2ae is used to store an aggregated group of customers based on similar energy information characteristics prior to an energy auction. This is useful to allow customers with similar energy requirements to be handled as a group. Aggregation grouping involves the gathering of different customer accounts for purposes of bulk power purchasing, coincident metering, bill consolidation, transmission capacity reservation, and load analysis Present day utility customers are, in effect, already “aggregated” into rate classes, but only to the point of developing a rate based on an assumed typical load profile. Each of these options allows for reshaping of loads without major alterations to enduser facilities. Groups are formed based on energy information that is served up from the Customer Energy Information Database which includes Raw Data Table 2l in 15-minute intervals, Daily Data Table 2m in 1-Hour intervals and Monthly Data table 2n. Table I, below, illustrates an example of the factors that can be used to define a given group for Natural Gas Purchasing.

TABLE I
Natural Gas Purchasing Grouping Parameters

Current Contract Start Date and End Date - Terms defining the time in-
terval a customer is under legal contract with a supplier for the delivery of
natural gas
Commitment - Firm Service - Natural gas that is purchased by a customer
that cannot have their gas supply interrupted or curtailed
Commitment - Interruptible - Natural gas that is purchased by a customer
who can either accommodate interruptions of their natural gas supply or
who have an onsite alternate or backup fuel source
Local Distribution Company (LDC) - The company providing the
transmission and distribution services
Pricing - City Gate - The price of natural gas delivered to the LDC service
territory
Pricing - Burner Tip - The price of natural gas from the supplier to the
enduser, inclusive of transmission and distribution charges
Service Rate Classification - The rate classification determined by the
LDC based on usage requirements. Small users are in different rate classes
than are larger users
Pipeline (i.e., CNG, Empire, etc.) - primarily based on location. Certain
pipelines service specific geographic regions, therefore creating an
aggregation group of customers requiring the same pipeline requirements
allows suppliers to manage pipeline capacity more efficiently
Facility Type - Grouping customers by facility type allows suppliers to bid
on like profiles. (i.e., schools, hospitals, apartment complexes, etc.).

Table II, below, illustrates Electric Grouping Parameters that can be used to define a given group for Electricity Purchasing.

TABLE II
Existing Contract Start Date and End Date - Same as above
Commitment - Firm - Same as above
Commitment - Interruptible - Same as above
Local Distribution Company (LDC) - Same as above
Pricing - City Gate - The price of electricity delivered to the LDC service
territory
Pricing - Meter - The price of electricity delivered to the customer meter
inclusive of transmission and distribution charges
Service Rate Classification - Same as above
Facility Type - Same as above
Load Factor - the ratio of average load to peak load during a specific
period of time, expressed as a percent. The load factor indicates to what
degree energy has been consumed compared to the maximum demand or
utilization of units relative to the total system capability. (i.e., Total kWh
consumed over a time period divided by the Peak kW within the time
period × the number of hours within the time period. kWh/(Peak kW ×
Hours)

The factors in Table III are used to organize customers into groups based upon the following load factor ranges.

TABLE III

| Level 1 | | Load Factor Grouping Parameters |
|---|---|---|
| Group 1: | 0.0 | 0.10 |
| Group 2: | 0.11 | 0.20 |
| Group 3: | 0.21 | 0.30 |
| Group 4: | 0.31 | 0.40 |
| Group 5: | 0.41 | 0.50 |
| Group 6: | 0.51 | 0.60 |
| Group 7: | 0.61 | 0.70 |
| Group 8: | 0.71 | 0.80 |
| Group 9: | 0.81 | 0.90 |
| Group 10: | 0.91 | 1.00 |

Location Information Table 2af is linked and joined to table 2u which stores location specific information for customers that have multiple locations. Location table includes location name, service address, meter number, utility account numbers, supplier account numbers, facility size, annual energy bills, contact name, LDC company name and account number, information regarding existing energy contracts and utility service rate classification. When an auction is completed customer information is provided to the supplier and supplier information is provided to the customer. Customer information is provided to the supplier for delivery purposes. Location information is required in order to map customer energy, demographic, and Request for Proposal (RFP) information into the Auction Grouping Table 2ae.

This information is used in the energy auction procedure discussed below.

Profile Table 2ag is linked to the customer energy information database interval energy data allowing suppliers to evaluate time of use usage patterns for individual consumers or an aggregated group as a whole. For example, this table can be used to determine peak, shoulder and off-peak times. Profiling individual users or aggregated groups allows customers to select multiple suppliers to meet their energy requirements during different time periods of any given day and/or season. In addition Suppliers have a more accurate means of nominating their requirements to the Independent Systems Operator (ISO) resulting in further reductions in energy costs to the consumer. Accurate assessments of risk management are of significant benefit to energy suppliers as their need to develop forward pricing models develops in the future.

Registration Table 2ah stores both customer and supplier demographic and billing information. The preferred embodiment requires such information from customers and suppliers before an account is created. This table contains information such as Company Name, Contact Name, Address, Phone Number, Email Address, Fax, Accounts Payable, Credit References, etc. Customer and supplier account information is used to match supplier and customer information upon completion of a successful bidding auction. This information is used in the energy auction procedure discussed below

Security Database

Security Database is the fifth major database component of database server 1d. Encompassed by this database is a single login table 2ai, which stores a customer username, password, and user permissions

B. Energy Information WWW Interface

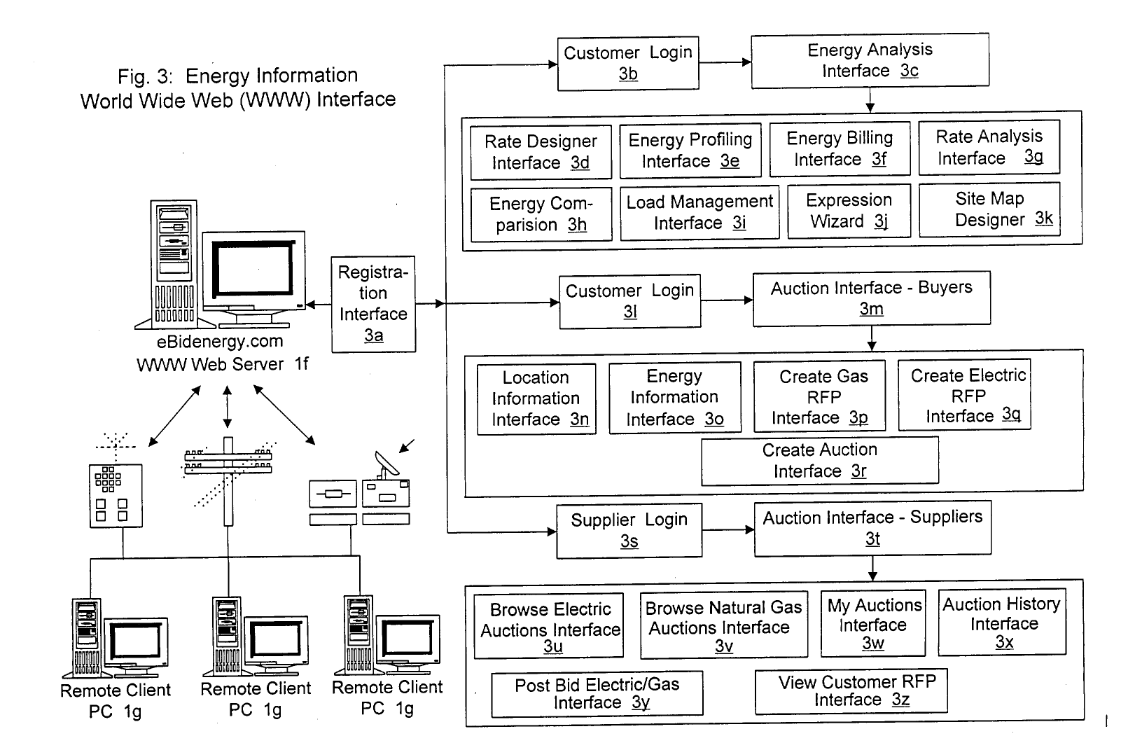

In FIG. 3, World Wide Web Server 1f is a computer that serves up information to other computers—specifically, client desktop PC's. The server distributes information from the Customer Energy Information Database (CEID) and Energy Auction Database (EAD) to remote PC users, as they need it on a per-request basis. WWW server manages the user-interface portion of the application, validates data entered by the user, dispatches requests to client programs, and executes energy information analysis logic. In addition, WWW Server houses several software applications required in order for remote clients to perform energy information data extraction queries. Installed software applications can include an Internet Information Server, Site Server, Commerce Server and a host of software development tools. Portions of the WWW server have restricted access where authenticating user names and passwords permit access.

In FIG. 3, Remote Client PC's 1g, invoke a process (program) that sends a message to WWW server 1f requesting energy analysis and/or energy auction information based on specific user defined criteria. Remote clients request information using the form based user-interface portion of the application allowing data entry, document requests to server programs, and execution of energy information analysis logic. The client-based process is the front-end of the application that the user sees and interacts with. The client process contains solution-specific logic and provides the interface between the user and the rest of the application system.

In FIG. 3, network hardware components 1b represent network communication devices, such as routers, modems, Ethernet gateways and/or radio transceivers and/or a combination thereof and link with communication lines 1c of FIG. 1, that are required in order to establish communications between FIG. 1's database server 1d, FIG. 3's WWW server 1f and FIG. 3's remote client PC's 1g. Communication lines 1c may include the Internet, phone lines, cellular communications and/or a combination thereof.

Functions provided by WWW server 1f are broken out into three major groups as Energy Analysis Interface 3c, Auction Interface—Buyers 3m and Auction Interface—Suppliers 3t.

Energy Analysis Interface.

Within Energy Analysis Interface 3c is customer login function 3b. This function performs customer username and password authentication to enable customers with data hosting and energy analysis accounts to view their energy information. Post authentication allows users to navigate freely within their environment. The customer's web environment allows each customer to access only that customer's energy information. Customer's are not free to navigate into another customer's web environment to view and/or analyze energy information.

Rate Designer Interface 3d allows users to create published supplier tariffs and create a custom tariff library. Having the ability to define an unlimited number of tariffs allows users to model their existing profiles against new and/or custom tariffs. The Rate Designer Interface gives users extensive flexibility in defining multiple fuel pricing structures, electric usage data, and analysis options through the use of a user-friendly interface.

Energy Profiling Interface 3e allows users to better manage energy usage and reduce costs. As a subscriber to the service, users will be able to gain immediate access to energy usage information through the eBidenergy.com™ web site. Once there, users will be able to view energy profiles on a daily, weekly or monthly basis 24 hours a day, 7 days a week. With the Energy Profiling interface users can perform the following functions listed in Table IV:

TABLE IV
Determine which facilities or processes are operating at maximum
efficiency;
Aggregate multiple sites into a single profile, giving a detailed overview
of collective energy usage company-wide;
Compare energy use patterns at multiple locations; and
Reduce energy costs by identifying inefficient processes.

Energy Billing Interface 3f allows customers to view their billing information prior to receiving a utility bill from an energy provider. This feature also allows customers to understand current usage and cost enabling customers to bill their own internal customers, bill multiple customers, consolidate billing, and make informed decisions before implementing energy or load management programs. Energy billing can also be used by suppliers and utility companies for online bill processing and consolidated billing functions.

Rate Analysis Interface 3g provides users the ability to accurately address and model many different types of rates, including regional rate mechanisms such as any utilities' bundled or unbundled rate structures. This product also allows you to maintain and track a history of changes to specific rate tariffs.

Some functions performed by the rate analysis module are listed below in Table V.

TABLE V
Analyze, propose, and negotiate special utility service contracts
Review & evaluate utility service tariff options
Analyze competitive market pricing and dynamics for generation,
transmission and distribution
Analyze unbundled utility tariff options & rates for transmission,
distribution and ancillary services
Prepare power supply request for proposals (rfp), evaluate offers, negotiate
with suppliers, and administer performance
Negotiate and contract with generation & transmission suppliers
Review proposed and approved utility bundled and unbundled services &
rates including stranded costs
Audit power usage, costs, & utility bills
Participate in restructuring proceedings
Evaluate distributed generation options
Evaluate municipalization options

Energy Comparison 3h allows a user to look at energy usage in two different time periods and compare the energy usage, Peak kWD, Min kWD, and Load Factor.

In FIG. 3, Load Management Interface 3i allows users to evaluate the shifting of electricity from daytime peak to shoulder Peak and/or Off Peak night use. Results of this type of analysis allow users to evaluate the energy cost savings for the portions of electricity they can move to Shoulder Peak and/or Off Peak. Shifting large Peak Demands to Shoulder Peak and/or Off Peak will make the Electrical Producer Generating Stations more efficient and the production of electricity less costly. Using Off Peak Night electricity replaces expensive fossil fuel generating equipment and can be minimized during peak daytime operations. Portions of an energy profile can then be modeled by the user selecting which time of day period they would like to model the current profile against This allows users to time slice portions of their energy profile and model against alternate time periods to evaluate potential cost savings and load management strategies. This also allows for the evaluation of distributed generation strategies should a customer wish to seek alternate suppliers for base load and use onsite generation to clip expensive peaks or fill valleys during periods of high and/or low usage.

Expression Wizard 3j allows users the ability to define algebraic expressions that are used to calculate demand and usage for aggregated groups of customers, buildings, individual processes, and/or single devices. The expression wizard also allows users additional functionality to edit existing expressions or delete existing expressions.

Site Map Designer 3k allows users the ability to create an expandable or collapsible name tree that gives the user a visual representation of corporation, division, building, process and device architecture. Users can define their location names, add edit or delete location names.

Auction Interface—Buyers

Within the Auction Interface, is customer Login function 31. This function performs customer username and password authentication to enable customers to view their auction information.

Location Information Interface 3n gives users the ability to view information about existing locations, add new locations, edit location information, or delete location information. Location information is required in order for suppliers to make informed bids during an active auction. The location information form, once submitted saves information to the location table in the customer energy information database and customer auction database.

Energy Information Interface 3o is an input form designed for users that are not currently metered customers. This form allows users to enter twelve months of usage and billing information needed in order to create an auction. Metered customers have the ability to select meters through a user input form that presents them with a listing of meters from the site map that can be selected and aggregated or summed into an auction. No manual data entry of customer energy information is required for metered customers. In addition users have the ability to edit/update energy information and/or delete energy information.

Create Gas RFP Interface input form 3p and Create Electric RFP Interface form 3q allow customers to input contract specific terms and conditions and energy profiles that suppliers must legally commit to prior to placing a bid for the customer profile. These RFP's can be generated on the fly from energy information currently archived in an energy information database. If a customer has more detailed RFP requirements above and beyond the standard form, they can attach a detailed word processing document prior to saving the RFP form. Suppliers will then have access to download this document for further review.

Auction Interface 3r allows users to view the status of their auctions that are currently in progress, extend auction dates, create new auctions, and delete auctions (only if no current bid).

Energy Auction Interface—Suppliers

Within the Supplier Auction Interface, login 3t performs supplier username and password authentication to enable suppliers to view Auctions.

Browse Electric Auctions Interface 3u and Browse Gas Auctions 3v summarizes in table format a listing of auctions by state and the number of active auctions in that state. When a supplier selects a state listing they are then presented with a summary table of each auction within that state. The summary table presents auction statistics such as peak demand, total usage, current bid and time remaining. Each auction ID is hyperlinked. Once the user clicks on a hyperlinked Auction ID, they are redirected to the bid form, FIG. 3y. The bid form displays summary statistics for that particular auction, along with a profile, data table, and a link to RFP information, FIG. 3z. RFP Interface 3z allows suppliers to view customer energy information only. Suppliers are not given information until the action in completed and there is a winning bid awarded and accepted. Once a supplier has viewed all the necessary information pertinent to making an informed bid, a bid is submitted and the user is returned to the browse auctions page.

My Auctions Interface 3w allows suppliers to view auctions that they are currently participating in, bidding summary, time remaining, highest bid, and lowest bid Auction History Interface 3x allows suppliers to view All auctions that they have participated in, winning bids, highest bid, lowest bid, and auctions won.

Energy Information Interface Flowcharts

C. Rate Designer Interface

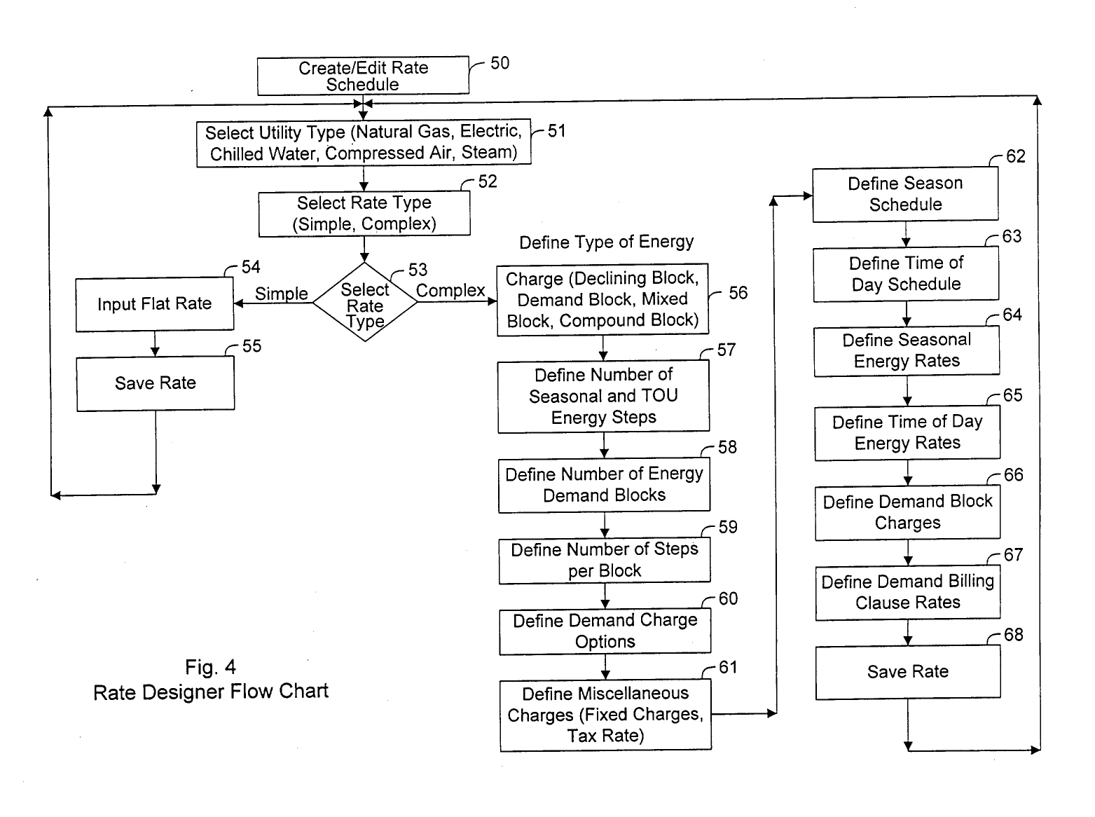

FIG. 4 is a flowchart that describes basic steps to create and edit a utility rate plan.

A utility rate plan contains options used to define electric, natural gas, chilled water, and compressed air energy-types rate schedules. This data is subsequently used in building, process, and device cost calculations. Rate schedules are database-linked to various data and tables such as 15-minute interval data 21, hourly interval data 2m and monthly interval data 2n.

In FIG. 4, the flowchart is entered at step 50 when it is desired to perform the task of creating or editing a rate schedule. In a preferred embodiment, the user operates a computer to access a server over the Internet. The server sends web page information that includes forms, or other data-entry fields, and prompts the user to fill in the forms to obtain the desired information.

At step 51, a menu option is used to select which type of utility the user wishes to evaluate. Steps 52-53 allow the user to select the type of rate plan, either standard simple, standard complex, retail access standard or retail access complex. Standard rate plans allow users to bundle commodity cost and Local Distribution Company (LDC) transmission and distribution charges. Retail access rate plans allow users to un-bundle commodity cost and LDC transmission and distribution charges.

The user chooses between a simple or complex rate type at step 53. A simple rate consists of one flat cost (e.g. $/kWh, $/Therm, $/TonHr, $/Mlb, etc.). A complex rate may consist of energy, demand, fixed, and tax charges. If a simple rate is specified, a flat rate input will be requested; no further electric rate inputs will be required. If a complex rate is specified additional user inputs will be required. If the user selects the simple rate option then step 54 is executed to obtain the flat cost per unit and the rate plan is given a name and saved, at step 55, to the rate table in the Customer Database.

If the user chooses a complex rate plan at step 53, then step 56 is executed where the user is given the opportunity to specify the type of energy charges. One of four types may be selected. These are Declining Block, Demand Block, Mixed Block, and Compound Block.

For Declining Block, Demand Block, and Mixed Block energy charges, the number of steps in the energy charge must be defined by the user at step 57. In an energy charge rate schedule, separate rates may be defined for different seasons, time-of-day periods or blocks of energy. Each of these rate specifications is referred to as a step in the rate schedule. An unlimited number of steps may be defined.

At step 58 the number of Energy Demand Blocks is defined. For Compound Block energy charges two alternate inputs are required instead of the number of steps, because the compound block charge has a two-tiered structure. Instead of having a series of rate steps, this charge has a number of demand blocks, and within each demand block are a number of rate steps.

At step 59 the number of steps per demand block must be defined by the user for the compound Block energy charge. In most compound block rate plans there are a varying number of rate steps per demand block. The largest number of steps per block should be entered.

At step 60 when a demand charge is used, or the energy charge involves measurement of electrical demand, the utility will define a procedure for determining the kW billing demand used to calculate charges. In some cases the billing demand is simply the actual maximum kW level during a specified billing period. Often this actual maximum kW is adjusted before charges are computed. The user will have the ability to define which, if any, of the demand determination clauses in Table VI are used:

TABLE VI
Ratchet Clause - Used to introduce a penalty when the difference between
monthly maximum kW values exceed a certain limit.
Trailing Window Clause - is also used to introduce a penalty when the
difference between user defined period maximum kW values exceed a
certain limit.
Minimum kW Clause - is used when the utility specifies a minimum value
for use in demand charge calculations. If actual maximum kW is less than
the utility specified minimum, the minimum value is used to calculate
demand charges.
Power Factor Multiplier Clause - introduces a direct charge for the
reactive component of power. Reactive power is used to create a magnetic
flux necessary to operate inductive machinery such as fans, and
compressors. The indirect charge is made by inflating the kW demand
value.
Power Multiplier Clause - is used to adjust measured kW values for
certain times of the year or times of the day before maximum kW values
are identified and charges are calculated. This clause is used to introduce
rewards for power use during certain times of the year or times of the day
when the utility has excess capacity.

At step 61, Miscellaneous charges are defined. These charges typically consist of a fixed meter charge, state sales tax, gross revenue taxes, business development credits, etc.

Taxes are computed based on the total of energy and demand charges. Step 62 handles seasonal scheduling. Utility rates can include separate rates for different times of the year. Most often, these times are associated with seasons. The users may select up to four seasons, Spring, Summer, Winter, Fall. A season is associated with each month. When seasonal scheduling is employed, utilities typically define summer, winter, and mid season, mid season being spring and fall.

At step 63 time of day scheduling is specified. This allows users to separate rates for specific time of day periods. Utilities use a very wide variety of names to designate the different periods such as peak, shoulder, partial peak, intermediate, mid peak, normal, off peak, etc. The users will have the ability to enter data for all hours of all day types for each season. If seasonal scheduling is not used, one table will be available for all seasons. In cost calculations, energy and demand charge rates defined for each particular season and period will only be used for energy use and power levels during the hours that period is in effect.

At steps 64-65, users have the ability to define energy charges for Declining Block, Demand Block, and Mixed Block. An additional user input screen is available should the user select a Compound Block Energy charge. For Declining Block, Demand Block, and Mixed Block energy charges a common interface which applies to all three rate types allows users to define the energy charges for the season, time of day period, and block size. For compound Block energy charges the users has the ability to define energy charges for the block size, and the steps within the block size.

Step 66 allows users to define the demand charges. These charges can be applied by season, time of day period, and/or block size.

Step 67 allows users to define any demand charge clauses as described in At step 60.

At step 68, a user saves the rate schedule and returns to main menu to create another rate schedule or to exit the module.

D. Generate Energy Profile

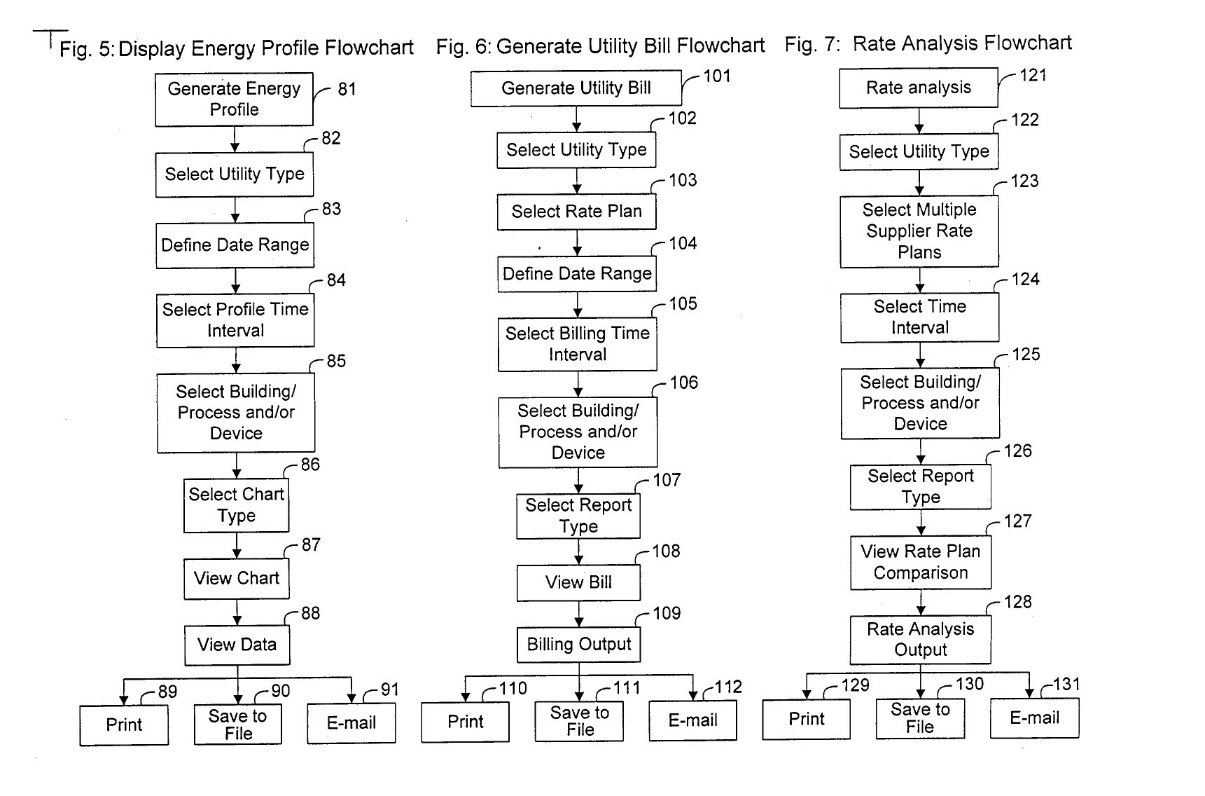

FIG. 5 is a flowchart showing basic steps in a routine to generate an energy profile. This feature allows a customer to use actual or hypothetical data to predict and analyze energy needs. A graph of a customer's energy consumption as a function of time is referred to as the customer's “energy profile.”

Some functions provided to the customer to create and modify an energy profile include those in Table VII, below.

TABLE VII
Display 15-minute, hourly, daily, weekly, or monthly data
Lock one day, week, or month on screen and compare it to any other day
week, month or user selected time period
Evaluate individual data values
Graph data in various ways
Shift profiles into different seasons and time of day periods
Print graphs
Copy, paste, download data and/or graphs into other Windows based
products

The routine is entered at step 81 when a user (i.e., customer) desires to generate an energy profile.

At step 82 the user selects a utility type as, for example, electric, natural gas, chilled water, steam or compressed air.

At step 83 the user has options to define the date range for reporting profile information.

At step 84 the user selects the time interval to display, 15-minute, hourly, daily or monthly.

At step 85 the user selects a customer location, building, process and/or device from the site map (name tree). This information is linked to the Customer Energy Information Database.

At step 86, the user selects a chart type and report type as either graphical, tabular or a combination of graphical and tabular. Graphical reporting output includes line charts, bar charts, pie charts, etc., which graphically represent time of day, seasonal or a combination of time of day and seasonal usage patterns. Tabular reporting output includes key usage statistics as seasonal and time of day usage patterns, load factor, peak co-incident demand values and the date and time of occurrence, the percentage of a building/process/device peak demand to coincident demand peak demand.

At step 87, the user can view report output before selecting user output options. Steps 89-91 represent user output options of print, file save, e-mail.

E. Generate Utility Bill

FIG. 6 is a flowchart describing the task and user interface for generating a utility bill. After selecting an energy provider of choice customers often need to generate bills prior to receiving the actual bill from their energy provider. This is the case, for example, for commercial users of energy, such as institutions or companies. In addition, many customers are moving to internal departmental billing in order to force the utility cost of ownership of a building, process and/or device to an individual budget center. Budget center billing increases the awareness of utility costs associated with a particular process and improves efficiency by forcing internal departments to be more critical of their operations. Billing for building, process and/or devices is calculated based on peak co-incident demand (i.e., the date and time at which the peak of buildings, processes, and or devices is co-incident with the utility companies peak demand date and time stamp).

At step 101 the user selects the Generate Bill icon from a main menu (not shown). This launches the task described by the Customer Energy Information Database flowchart.

At step 102 the user selects utility type, electric, natural gas, chilled water, steam, compressed air, etc. At step 103 the user selects a rate plan. Predefined rate plans are stored in the Customer Energy Information Database. In a preferred embodiment, these are customer-designed plans. However, the plans may be obtained from another source, also.

At step 104, the user has options to define the date range for reporting billing information.

At step 105, the user selects the time period and interval in which to report billing information. Time intervals include 15 minute, Hourly, Daily, Weekly, Monthly. This data is linked to the customer information database.

At step 106, the user selects the company, division, building, process, and device or a combination thereof from the customers building expressions site map. Customer building expression site map is stored in the customer database node table.

At step 107, the user selects a report type either graphical, tabular and/or a combination of graphical and tabular. Graphical reporting output consists of line charts, bar charts, pie charts, graphically representing Time of Day and seasonal or a combination of Time of Day and Seasonal usage costs.

At step 108, the user has the ability to view reporting output before selecting user output options.

Steps 109-112 represent user output options of print, file save, e-mail.

F. Rate Analysis Module

FIG. 7 shows a flowchart of a routine and user interface to compare rates and service plans. Energy consumers are often asked to choose energy providers based upon offerings that are often complicated and confusing. The challenge faced by energy purchasers is to make good decisions in order to get the most for their money, while converse responsibility of energy sellers is to assist their customers in understanding rates and to explain the effect on the customers bottom line. Utility rates are complex, and the data used to generate the billing determinants are vast. Because the pricing schemes themselves incorporate a myriad of factors and dependencies, they are difficult to evaluate and nearly impossible to compare directly. The rate analysis module allows users to make comparisons between multiple rates and see what bills would be under each one for a given usage pattern. An energy customer can then sift through the various offerings themselves and determine which rate plan provided by which energy seller is best suited to their needs.

The routine of FIG. 7 is entered at step 121 when the user desires to perform rate analysis.

At step 122 the user selects a utility to evaluate. Utility types include Electricity, Natural gas, Chilled Water, Steam, and Compressed Air.

At step 123 the user calls up specific rates that are stored in the rate library. See FIG. 4, steps 50-68 for creating and editing rate plans.

At step 124 the user selects the time period and interval in which to compare rates. Time intervals include 15 minute, Hourly, Daily, Weekly, Monthly. This data is linked to the Customer Energy Information Database 21, 2m, and 2n.

Step 125 allows the user to select the company, division, building, process, and device or a combination thereof from the customers building expressions site map stored in the node table 2q.

At step 126 the user selects a report type either graphical, tabular and/or a combination of graphical and tabular. Graphical reporting output consists of line charts, bar charts, pie charts, graphically representing Time of Day and seasonal or a combination of Time of Day and Seasonal usage costs.

At step 127 tabular and/or graphical reporting output includes key costing statistics. Graphical and tabular output for each rate plan is compared to a user selected baseline plan.

At steps 128-131 rate analysis output allows users to either download output for use in other third party software applications, or to print or e-mail the output, etc.

G. Create Commodity Request For Proposal

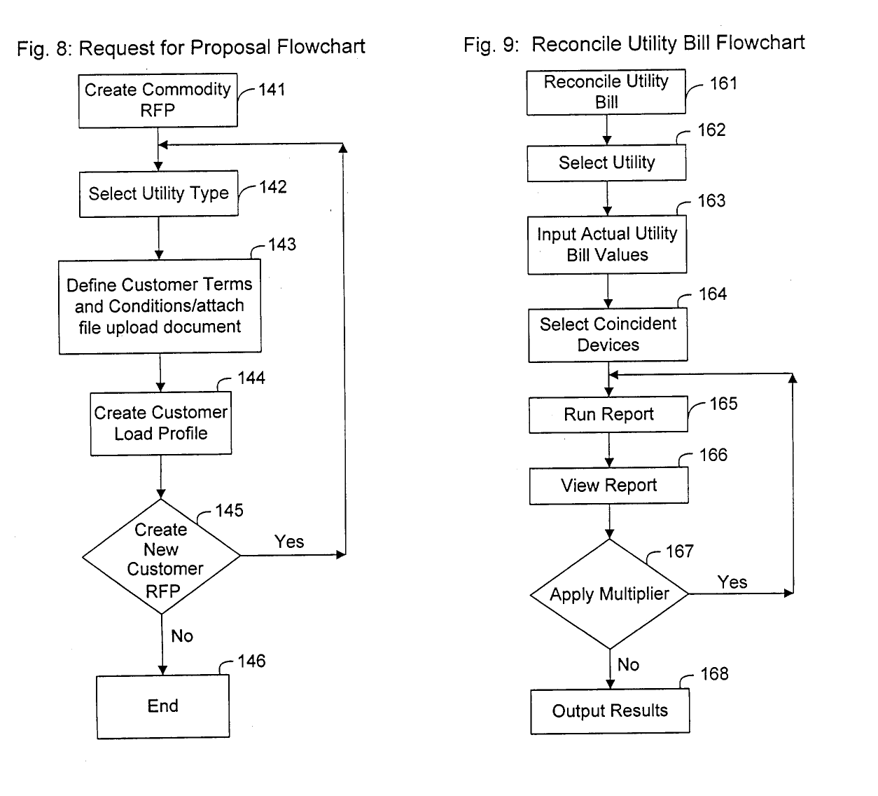

FIG. 8 is a flowchart describing a routine and user interface for creating a Request for Proposal (RFP). An RFP is a description of a customer's energy needs, terms and conditions and desired payment plan and is an invitation for an energy supplier to bid to fulfill the requirements of the RFP's terms for supply and payment of energy. RFP's are used by energy consumers to competitively procure energy. RFPs are also used by energy providers to competitively bid on a customer energy usage profile. In addition, when energy providers bid on customer profiles, they need assurance that they are all bidding on the same customer requirement, otherwise there would not be an apples to apples comparison. The commodity RFP outlines all of the customer requirements prior to going out for competitive bid. These requirements might include the customers existing contract begin date and end date, type of contract (i.e., firm commitment, non-firm commitment), duration of contract (i.e., spot market, 3 month strip, 6 month strip, 12 month strip, etc), customer strike price (i.e., the maximum price a customer is willing to pay for commodity), title transfer, type of pricing (i.e., city gate, all-up-and-in, burner tip, etc.). Commodity RFP's also include the customers energy profile.

At step 141 the user selects Create Commodity RFP icon to launch the routine described in Security Database tables.

At step 142 the user selects the utility type for RFP creation. Utility types include electricity and natural gas.

At step 143 the user defines their terms and conditions required to execute a commodity transaction. If additional information is required outside of the standard input form, an attach document file is available for upload. Suppliers can then download this additional information prior to posting a bid.

At step 144 the user selects their interval energy profile for inclusion into the RFP. Energy providers require this information in order to nominate their needs to the generating companies. Customer energy profile is stored in the customer energy information database.

At step 145 the user has the option of creating another RFP or saving the newly created RFP to the Customer Energy Information Database of FIG. 1.

At step 146 the user ends RFP session.

H. Reconcile Utility Bill

FIG. 9 is a flowchart describing a routine and user interface for reconciling utility bills. This offers users the ability to compare their own internal metering system with a utility metering system. Customer installed utility meters installed at lower levels than utility installed meters inherently report lower energy values than utility meters due to line losses inherent in any electrical distribution system.

Users need a way to compare lower level meter line losses to the utility meters in order to implement accurate internal billing functions. The method for implementing bill reconciliation requires the user take an actual utility bill and input all pertinent data into a reconciliation form. The user must then select the top-level customer meters that are at the same level as the utility meters. Once all data entry is complete the user executes a comparison routine. The result set is returned to the user. Report results include the utility meter time of day and seasonal values in column A, the values from the customers metering system in column B, and a percentage difference in column C. The users now have the option of applying the reconciliation factor to all buildings, processes and/or devices that roll-up to the top-level utility meters.

At step 161, the user selects reconcile utility bill icon to launch the routine.

At step 162, the user selects the utility type.

At step 163, the user inputs actual utility values in reconciliation input form.

At step 164, the user selects top level on-site metering devices.

At step 165, the user executes comparison routines.

At step 166, a report is returned summarizing reconciliation results.

At step 167, the user has the option to apply the reconciliation factor to the appropriate buildings, processes, and/or devices.

At step 167 if the user chooses to apply a reconciliation factor then the reconciliation factor is applied to the user-selected buildings, processes, and/or devices. Another report is returned to the user showing a balanced and reconciled utility bill.

Else, the results are output at step 168 and the routine is exited.

I. Missing Data Validation Report

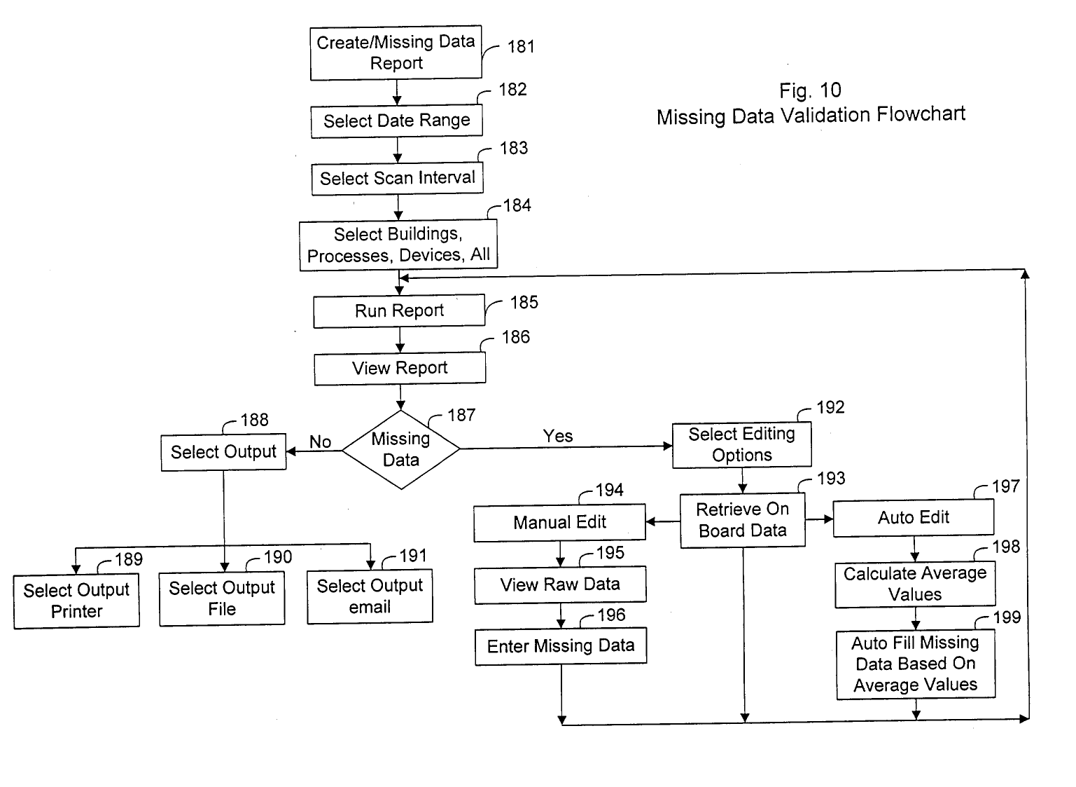

FIG. 10 is a flowchart that describes a routine and user interface to create and edit a “Missing Data” report. The purpose of this routine is to allow users to evaluate the validity of data prior to the profiling, billing, and bidding of energy. In some cases data could be lost due to communication problems. Typically, utility and customer meters have the capability of storing data on board the metering device for limited intervals of time. Should communications be interrupted, the user first has the ability to query the data out of the database, to determine what devices are missing data. The reporting feature of the missing data module allows users to capture a snapshot of the missing data. The users then have options, which include retrieving data from onboard the metering device or manually entering data into the database to fill the gaps. At a minimum, data validation must be able to detect the following conditions so that erroneous data will not be used for billing or profiling purposes. All validation can be done manually or automatically.

Validation Of Metering Data

Gaps in data

Overflow of data within an interval

Validation Of Load Profile Characteristics

Validation of load patterns against historical load shapes

Validation criteria must be defined for each channel of load profile data (kW, kWh, Therms, Tons, etc.) since the load characteristics are different for all meter locations and the type of data being recorded. Some validation criteria may not be applicable to all meters or types of data. For example, percent change between intervals is an excellent validation criteria for loads that do not change significantly over time or change in a predictable manner. However, this validation check would be meaningless for loads that switch from no-load to load.

The best validation criterion is based upon historical data for that meter location.

Validation Guidelines

Since metering data will be retrieved on a frequency basis of 15 or 60 minutes, validation should be performed on a daily or hourly basis in order to detect missing data.

In the following table, “Hourly” is used to define the validation criteria that will be used as data is retrieved on a frequency of 60-minute intervals or less. “Daily” is used to define the validation criteria that will be used to validate data at the end of each day or when the supporting data becomes available.

| Validation Criteria | Manual | Daily |
|---|---|---|
| Missing Intervals (Gaps In Data) | Yes | Yes |
| Hardware Reset Occurred | Yes | Yes |
| Data Overflow In Interval | Yes | Yes |

Data that fails validation will be flagged with the reason for the failure where applicable. Data that fails checks such as comparison of a load profile to the previous day, or other load shape will be identified so that manual intervention can be used to edit the data or to manually accept the data.

Data validation will be performed only for the validation criteria that has been entered for each meter or process expression for each channel of data. For example, the number of intervals of zero energy recorded by the meter for the channel indicated will be validated only when a non-zero value is entered for this criteria. These criteria would not be of any value to a meter that has no energy recorded for significant time periods due to no load at the delivery point.

Validation Algorithms

1. Missing Intervals (Gaps in Data)—This process compares the start and stop times within the customer energy information database tables 21, 2m, 2n and reports if a missing data situation exists.

2. Meter Reset—If a meter is replaced or registers reset to 0, then a data must be adjusted to compensate for “less than” 0 values

3. Meter Register Overflow-Meter data condition that occurs as the result of a spike exceeding a maximum value, register overflows detected, or demand value exceeds maximum limit.

Data Estimation Criteria

When interval data is missing due to lost communications the missing data routine will supply estimated data for the missing intervals based on the following guidelines. When reading meters on a frequency basis, the linear interpolation method will be used to estimate the current interval(s) of data if missing data exists for 1 hour or less. If data is missing for an extended time period, historical data will be used as the reference data so that data can be matched to season, day type (i.e., weekday, weekend, holiday) and time of day (i.e., peak, off peak, mid peak).

Data Estimation Methods

The following data estimation methods are configurable by the user on a meter by meter basis. The algorithms for each method are described below in order of precedence as implemented by the e-Ware automatic estimation software. The user can alter this order by simply not activating a certain method. In addition, the user can manually select each data estimation method at any time during the data analysis process.

1. Linear Interpolation—When reading meters on a frequency basis, the linear Interpolation method can be used to estimate the missing intervals of data. This method is only recommended to estimate a maximum of one hour of missing data when the previous and next intervals are actual values from the meter.

Linear Interpolation Algorithim

Next Value−Previous Value

Estimated Value=Number of Missing Values+1+Previous Value

3. Historical Data Estimation—Historical data estimation is the process of replacing missing or corrupt interval data in customer energy information database tables. The missing data gaps are filled using an historical database table as a reference.

4. The reference data table is based on Seasons (Fall, Spring, Summer, Winter), Day Type (weekday, weekend, holiday) and Time of Day (i.e., peak, mid peak, off peak).

At step 181 the user selects enters the Create/Edit Missing Data Report routine.

At step 182 the user selects a date range in which to generate report.

At step 183 the user selects the time interval in which to query data. Data intervals include 15 minute, hourly, daily, weekly and monthly.

At step 184 the user selects division, building, process, and device in which to report missing data.

At step 185 the user executes missing data query.

At step 186 a report is returned to the user that summarizes the date and time of missing data points by division, building, process and/or device by quantity (i.e., kW, kWh, etc).

At step 187 the user has an option to output results, edit or retrieve data.

At steps 188-191 if there are no edits, the user has the option to output report results to a printer, a file or e-mail or a combination thereof.

At step 192 the user selects editing options.

At step 193 the user retrieves onboard meter data, fills data gaps (i.e., missing data) and re-runs the report to ensure that no missing data exists.

At steps 194-196 a manual edit mode allows the user to view raw data and fill the gaps. A user-input form is provided.

At steps 197-199 the user executes an auto gap fill query that statistically evaluates data prior to the first occurrence based on seasonal, and time of day historical data and then fills the gaps.

J. Create/Edit Expressions

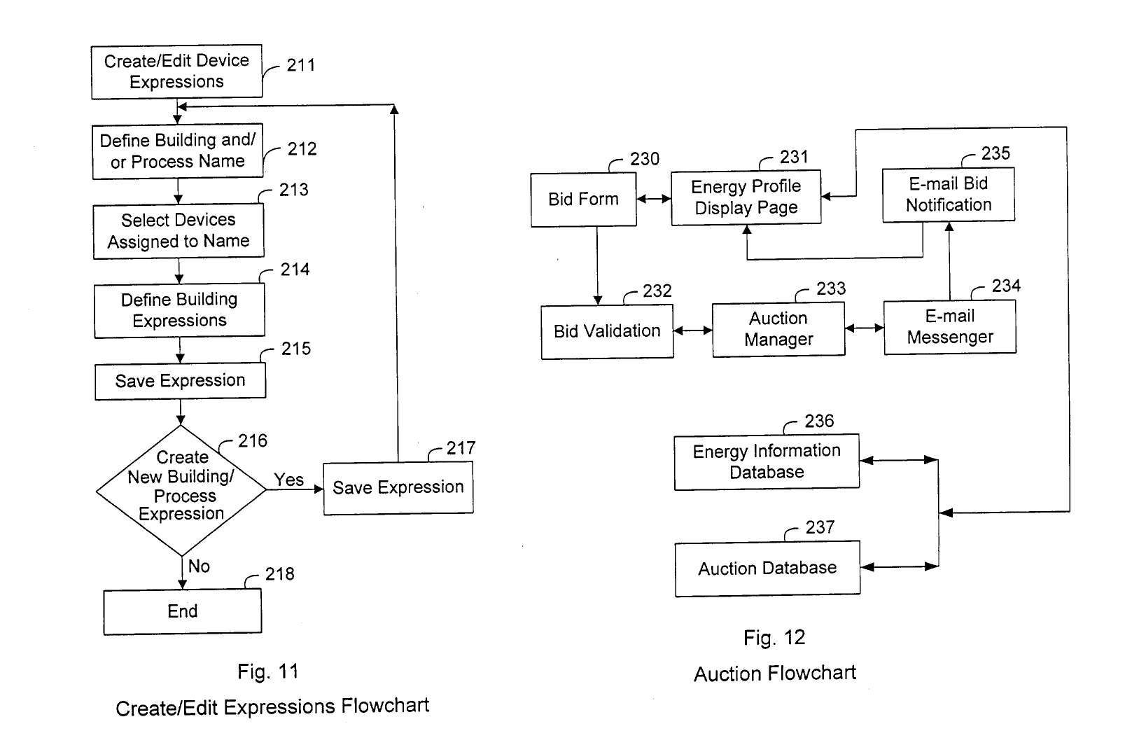

FIG. 11 is a flowchart describing a routine and user interface to allow creation and editing of“device expressions.” This allows a user to define mathematical expressions that may be required to group devices into division groups, building groups and process groups. Once the grouping is complete users will have the ability to define the mathematical expression required for profiling, billing, aggregating and disaggregating devices. An expression's input form is provided for the user. Device expressions can be modified or changed at any time during a users session.

At step 211 the user initiates the Create/Edit Device Expressions task.

At step 212 the user defines division, building, and process name.

At step 213 the user selects devices and assigns them to a division, building, and process name.

At step 214 the user defines a mathematical expression of devices and assigns the expression a name.

At step 215 the user saves the expression to Customer Information Database 2y.

At step 216 the user has the option to create a new device expression.

At step 217 the user saves the expression to a customer information database and loops back in the routine to create new expressions, as desired.

At step 218 the user ends the session.

Energy Auction Process Flowcharts

Energy Auction flowchart FIG. 12 includes an energy information database 236 and an auction database 237 for maintaining detailed information of customer energy profiles up for auction, bids, and other relevant information in a commercially available database system. Database searches are performed periodically to check for new energy profiles and invite suppliers to bid on the updated energy profiles. Once the database is populated with information about the customer, the energy data and profile is scheduled for presentation to potential bidders. At step 230 the system reads energy profile information from the customer energy information database and the auction database in order to create a human-readable aggregated energy profile page for viewing over a public network such as the Internet's World Wide Web. At Step 231, bidders are then able to view the energy profiles up for auction and to place their bids. These aggregated profile pages preferably contain the current low bid, bid decrement, aggregated quantity available, profile description, and graphical profile of the energy consumption.

Upon accessing a public network and seeing an aggregated energy profile page, the bidder may press a button on the aggregated energy profile page or take some similar action which causes a bid form to be displayed on the screen. The bidder then enters the information necessary to place a bid, such as supplier name and address, bid amount, minimum bid amount, etc., and then presses a bid submission button, or takes a similar action which sends the bid to the system.

At Step 232, the system receives the electronic bid information and places it in the bid database. Because this new bid will, in general, be a bid for a lower amount than was last bid by another party, the system will regenerate the energy profile bid page. This updated profile bid page will then show the new low bid to any prospective bidders who later access the system for the purposes of placing a bid.

Because most bidders will not, in general, be accessing the network and viewing the energy profile bid pages as they are updated with new low bids, the system may send electronic mail notifications to bidders at Step 234 who have been underbid by the just-placed bid. These electronic mail notification messages preferably contain the relevant energy profile information, the current low bid, the bid decrement, etc., and encourage the bidder to submit a new and lower bid to underbid the current low bidder at step 235. These electronic mail notification messages allow the bidder to enter a new bid by replying to the electronic mail message and sending it back to the system.

Upon receiving a new or revised bid via electronic mail, the system follows the same set of rules as when the bidder places a bid using the electronic bid form when viewing an aggregated energy profile page, namely, the system extracts the relevant bid information from the electronic mail message, deposits this information in the bid database, and then updates the aggregated energy profile bid page as appropriate. Such an electronic mail message bid may further cause a new round of electronic mail notifications to go out to the recently underbid bidders.

At step 233, Auction Manager continues until the system detects that the aggregated energy profile is scheduled to be closed for further bidding or another closing trigger is detected. At this point, the system closes the auction by updating the aggregated energy profile page with the final winning bid information and by sending electronic mail notifications to both the winning bidder or bidders and the losing bidder or bidders.

Energy Auction Interface Flowcharts—Buyers

The present invention provides an electronic auction method and system for presenting energy profiles for sale at auction to energy suppliers over an electronic network, such as the Internet's World Wide Web. Potential suppliers are presented with a series of descriptive energy profile pages through which they may navigate to find profiles of interest. Upon finding an energy profile of interest, energy suppliers may click a button on screen to display a form for placing a bid on the profile. After submitting this bid the electronic auction system records the bid and updates the profile page to show the current low bid or bids and to whom such bids are attributable. When the auction is closed, after a period of no bidding activity, at a predetermined time, the electronic auction system notifies the winning and losing bidders by electronic mail and posts a list of the winning bidders on the closed energy profile page.

Registration Flowchart—Buyers

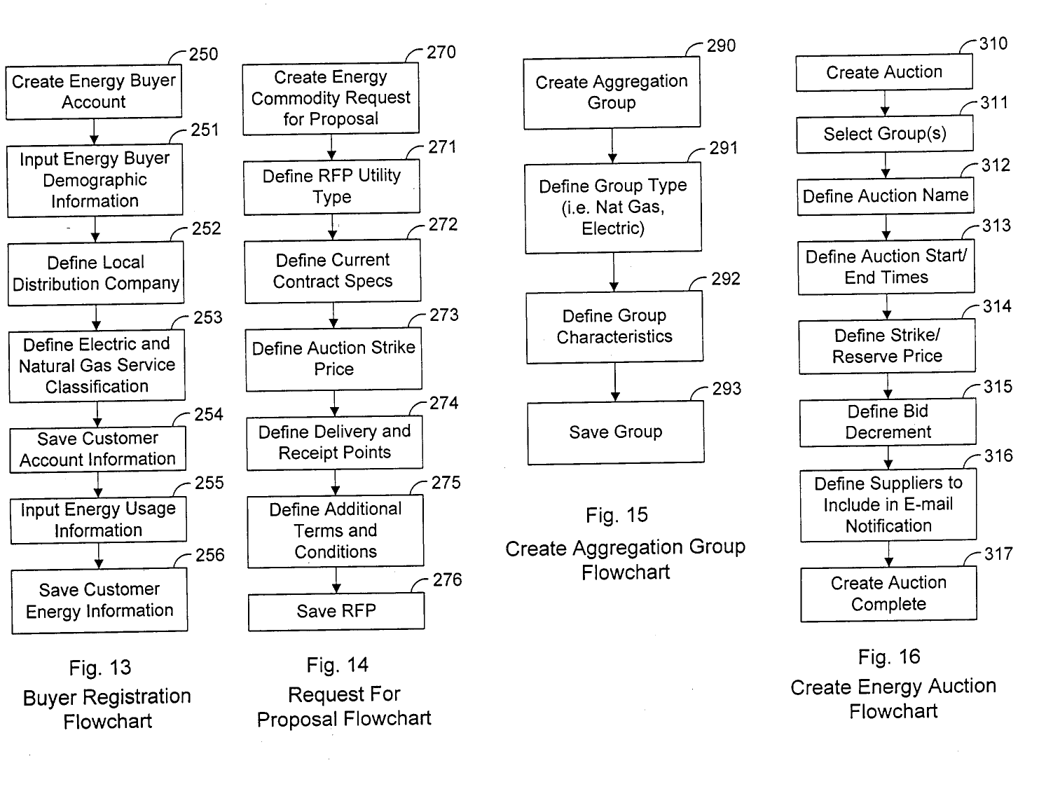

In FIG. 13, Energy Buyer Registration allows users and Logical Energy personnel to create energy buyer accounts.

At step 251 Input Demographic Information is a form based user interface requiring the user to provide the following information:

Company Name

Contact Name

Street Address

Phone/Fax

Contact E-mail

Credit Information

Facility Type

Square Footage

Annual Energy Costs

At step 252 Define Local Distribution Company (LDC) is required in order for suppliers to determine who is delivering energy to their location. LDC's are important to suppliers in that it dictates whether or not they can participate in an energy auction for a given local.

At step 253 Define Electric and Natural Gas Services Classification identifies the customer as a time-of-use or non time-of-use customer. This is of particular importance to suppliers who require a time of use profile in order to price commodity.

At step 254 upon completion of all demographic and utility information, the account is saved to the members database.

At step 255 Input Customer Energy Information allows online users as well as Logical Energy personnel to input energy usage data on a monthly basis.

At step 256 Customer Energy Information is saved to customer database.

Create Request for Proposal Flowchart

In FIG. 14, Create Energy Request for Proposal, allows users and Logical Energy personnel to define customer specific energy purchasing requirements.

At step 271 Define Utility Type allows users to define electricity and/or natural gas requirements that suppliers must agree to before a commodity transaction can be completed.

At step 272 Define Current Contract specifications specifies the duration of the existing contract (i.e., start date and end date).

At step 273 Define Auction Strike price allows users to specify the maximum price they are willing to pay on a commodity contract.

At step 274 Define Delivery and Receipt Points allows users to specify to prospective suppliers where they want to take possession of the commodity, either in state or out of state.

At step 275, additional terms and conditions can be attached to the RFP, which may contain detailed specifics that the standard form does not address. Additional terms and conditions can be attached to the RFP in the form of an MS Word document or any other ASCII text format for later viewing by suppliers.

At step 260 RFP is saved to RFP database.

Create Aggregation Group

In FIG. 15, Create Aggregation Group, allows users and LES personnel to group customers based on like characteristics.

At step 291 Defines group-type and categorizes customers into electric groups and/or natural gas groups. This information is used when creating an electric or natural gas auction.

At step 292 Defines group characteristics and allows users and LES personnel to group customers by like characteristics. Grouping elements are listed below.

Load Factor

Local Distribution Company

Facility Type

Utility Service Classification

Contract Start Date and End date

Strike Price

At step 293 Group is saved to auction database.

Create Auction Flowchart

In FIG. 16, Create Energy Auction, allows users and LES personnel to create an energy auction.

At step 311 Select Groups allows users to select groups previously created into their auction. Groups may consist of an individual site and/or multiple locations.

At step 312 Define auction Name allows users to define the name of the auction for supplier selection.

At step 313 Define Auction Start Date and End Date allows users to define the duration of each auction created.

At step 314 Define Strike Price allows users to set the maximum price they are willing to pay for a commodity. Suppliers must begin bidding lower than the predefined strike price.

At step 315 Define Bid Decrement allows LES personnel and/or users to set the amount each proxy bid will be lowered by until suppliers are either removed from the auction or are awarded the commodity contract.

At step 316 Define Suppliers to Include in the E-mail Notification is a feature that enables buyers to select who they want to participate in their auction. E-mail notifications are sent to each selected supplier upon auction creation.

At step 317 Create Auction Complete, once the auction has been created it is dynamically posted to the web for supplier bidding.

Buyer Auction View Flowchart

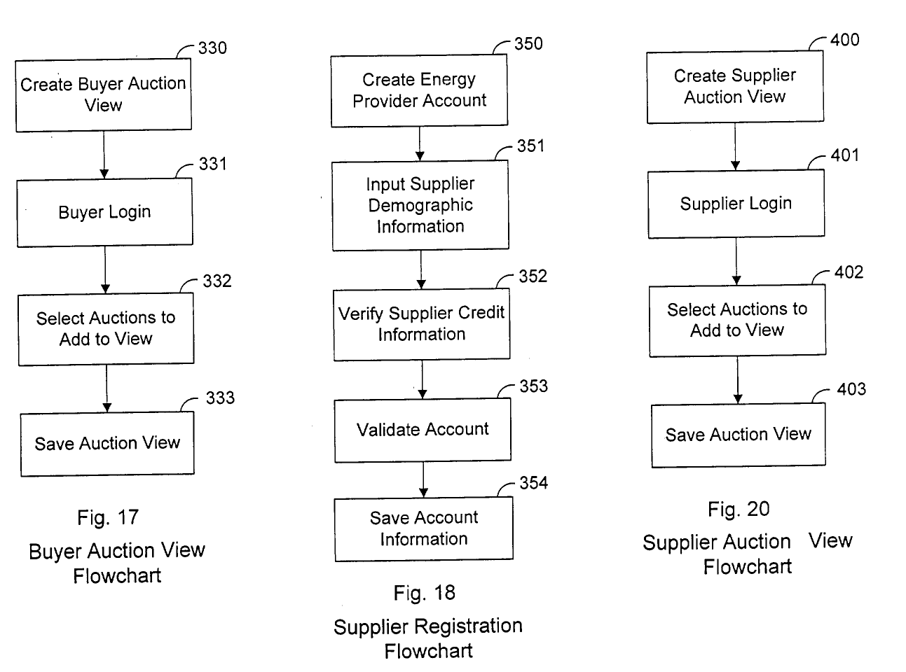

In FIG. 17, Buyer Auction View allows the buyer to view bids that have been posted to their group.

At step 331 Buyer Login is a form in which a buyer enters their user name and password.

At step 332 Select Auctions to Add to View allows the buyer to view their auction as it's happening on the Web.

At step 333 Save Auction View allows the buyer to save the auction they are viewing for later review and comparison.

Energy Auction Interface Flowcharts—Suppliers

Registration Flowchart—Suppliers

In FIG. 18, Energy Supplier Registration Process allows users and Logical Energy personnel to create energy supplier accounts.

At step 351 Input Demographic Information is a form based user interface requiring the user to provide the following information:

Company Name

Contact Name

Street Address

Phone/Fax

Contact E-mail

Accounts Payable Information

Credit Information

At step 352 Credit verification allows company personnel to verify credit information through online and traditional services such as Equifax, and Dun and Bradstreet (D&B) etc.

At step 353 Account validation is complete upon information provided by D&B.

Browse Auctions

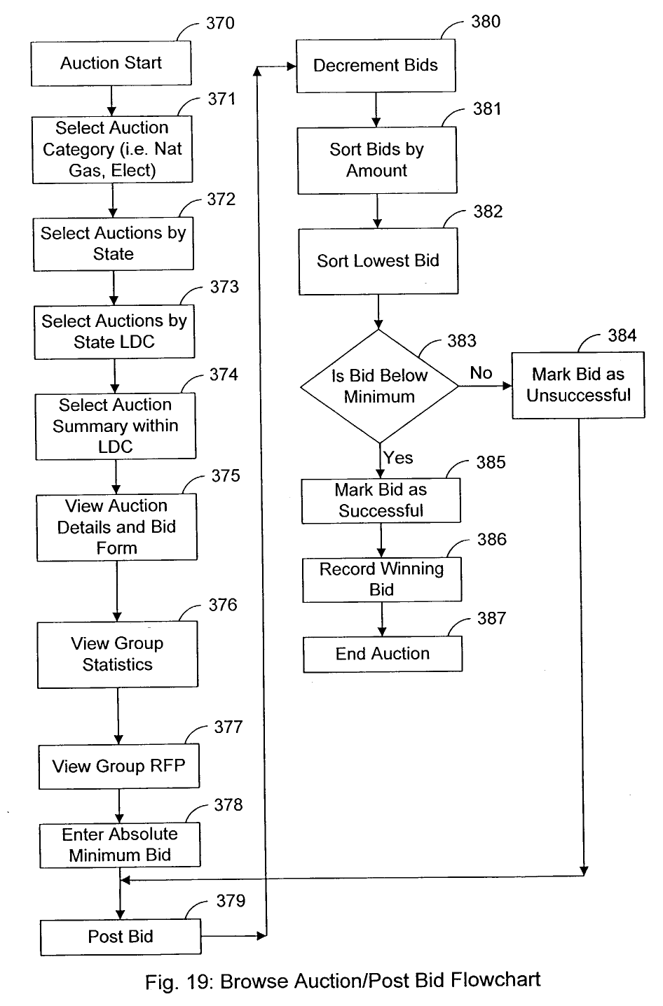

FIG. 19 Browse Auctions/Post Bid flowchart defines the logic in which an auction is conducted.

At step 371, Select Auction Category the user selects an energy category to view current auctions related to selected energy type.

At step 372, Select Auctions by State the user chooses a state in which to view an open auction.

At step 373, Select Auction by LDC the user selects an auction in a specific utility territory.

At step 374, Select Auction Summary within LDC the user can view the starting bid, current bid or ending bid and their bid for each auction they participated in within a specific utility territory.

At step 375, View Auction Details and Bid Form the user has the option to view the details (i.e., RFP requirements, summary of Usage, etc.) of the current auction.

At step 376, View Group Statistics the user has the option to view information regarding the multiple users that make up the group (i.e., aggregated group usage).

At step 377, View Group RFP the user can view the RFP requirements of the group as a whole.

At step 378, Enter Absolute Minimum Bid the user posts an absolute best bid that they will honor.

At step 379, Post Bid the user submits their bid for the current auction.

At step 380, Decrement Bids is a process in which all following bids are automatically decremented to meet or beat the lowest bid currently on the system.

At step 381, Sort Bids by Amount the system organizes the posted bids in order.

At step 382, Sort Lowest Bid the system ranks all bids showing the lowest offer as the current low bid.

At step 383, Bid Below Minimum verifies that the posted bid is not higher than the decremented default bid in the Bid Box.

At step 384, Mark Bid as Unsuccessful the system notifies the user that the posted bid was not low enough to be accepted.

At step 385, Mark Bid as Successful the system accepts the offer and posts it as the current as the low bid.

At step 386, Record Winning Bid the system records the lowest bid offered.

At step 387, End Auction an auction is automatically closed based on the lowest winning bid and/or the designated end date of an auction.

Supplier Auction View Flowchart

In FIG. 20, Supplier Auction View allows suppliers to view auctions that have been posted.

At step 401, Supplier Login is a form in which a supplier enters their user name and password.

At step 402, Select Auctions to Add to View allows the supplier to choose which auctions they want to view and bid on.

At step 403, Save Auction View allows the supplier to save the auction they are viewing for later review.

User Interface

A user interface for an energy consumer executes on a computer in communication with the system of FIG. 1. Such communication can be over a digital network such as the world-wide Internet. However, any type of communication channel using various physical links (e.g., electromagnetic wave, optical, wire, etc.) and any suitable transmission protocol can be employed. The energy consumer's computer is typically referred to as the “client” computer.

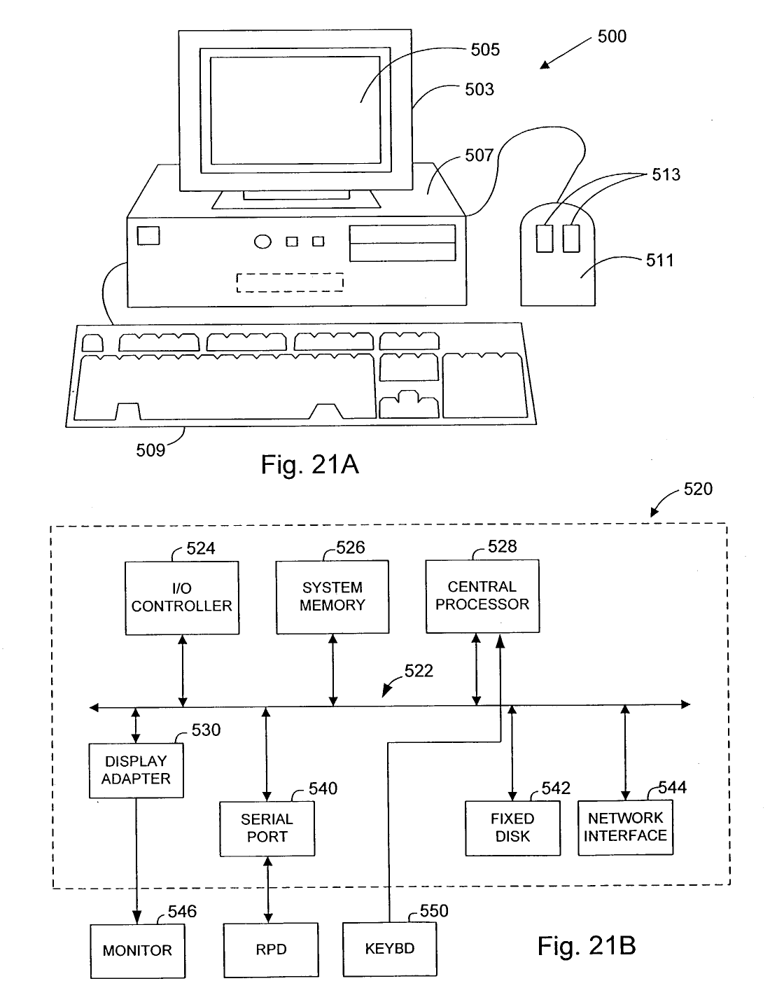

FIG. 21A illustrates a computer system suitable for use as the client computer in the present invention.

In FIG. 21A, computer system 500 includes display 503 having display screen 505. Cabinet 507 houses standard computer components (not shown) such as a disk drive, CDROM drive, display adapter, network card, random access memory (RAM), central processing unit (CPU), and other components, subsystems and devices. User input devices such as mouse 511 having buttons 513, and keyboard 509 are shown. Other user input devices such as a trackball, touch-screen, digitizing tablet, etc. can be used. In general, the computer system is illustrative of but one type of computer system, such as a desktop computer, suitable for use with the present invention. Computers can be configured with many different hardware components and can be made in many dimensions and styles (e.g., laptop, palmtop, pentop, server, workstation, mainframe, consumer electronic device). Any hardware platform suitable for performing the processing described herein is suitable for use with the present invention.

FIG. 21B illustrates subsystems that might typically be found in a computer such as computer 500.

In FIG. 21B, subsystems within box 520 are directly interfaced to internal bus 522. Such subsystems typically are contained within the computer system such as within cabinet 507 of FIG. 21A. Subsystems include input/output (I/O) controller 524, System Random Access Memory (RAM) 526, Central Processing Unit (CPU) 528, Display Adapter 530, Serial Port 540, Fixed Disk 542 and Network Interface Adapter 544. The use of bus 522 allows each of the subsystems to transfer data among the subsystems and, most importantly, with the CPU. External devices can communicate with the CPU or other subsystems via bus 22 by interfacing with a subsystem on the bus. Monitor 546 connects to the bus through Display Adapter 530. A relative pointing device (RPD) such as a mouse connects through Serial Port 540. Some devices such as Keyboard 550 can communicate with the CPU by direct means without using the main data bus as, for example, via an interrupt controller and associated registers (not shown).

As with the external physical configuration shown in FIG. 21A, many subsystem configurations are possible. FIG. 21B is illustrative of but one suitable configuration. Subsystems, components or devices other than those shown in FIG. 21B can be added. A suitable computer system can be achieved without using all of the subsystems shown in FIG. 21B. For example, a standalone computer need not be coupled to a network so Network Interface 544 would not be required. Other subsystems such as a CDROM drive, graphics accelerator, etc. can be included in the configuration without affecting the performance of the system of the present invention.

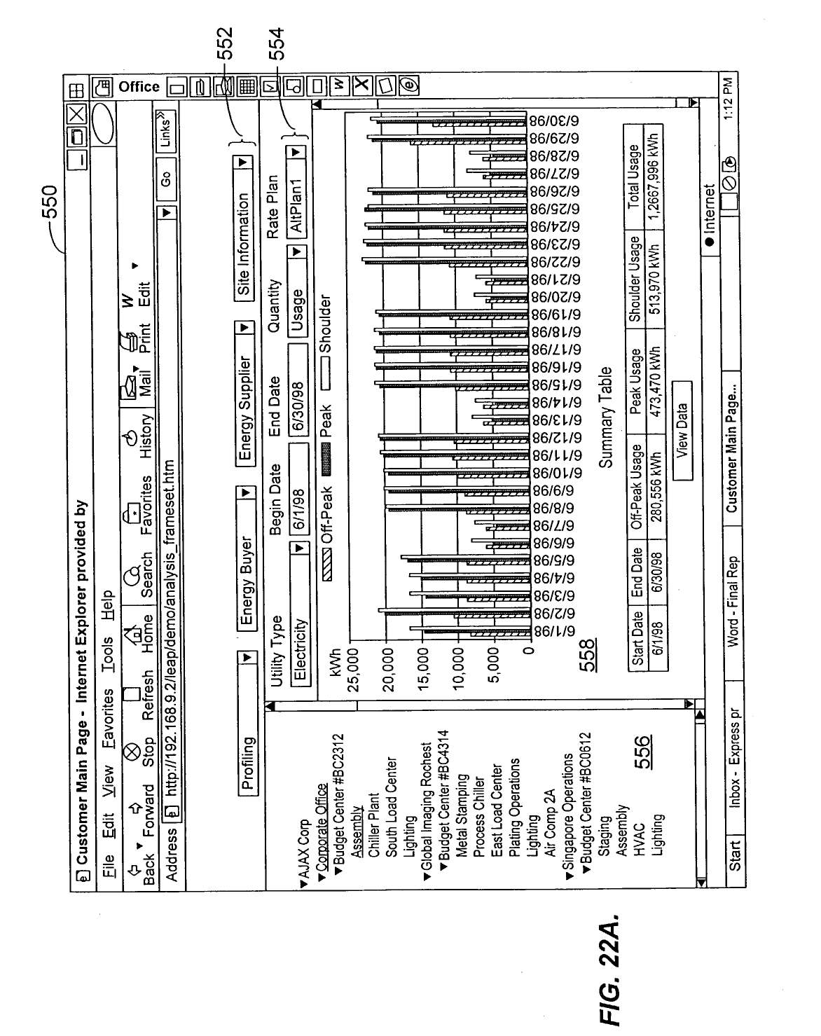

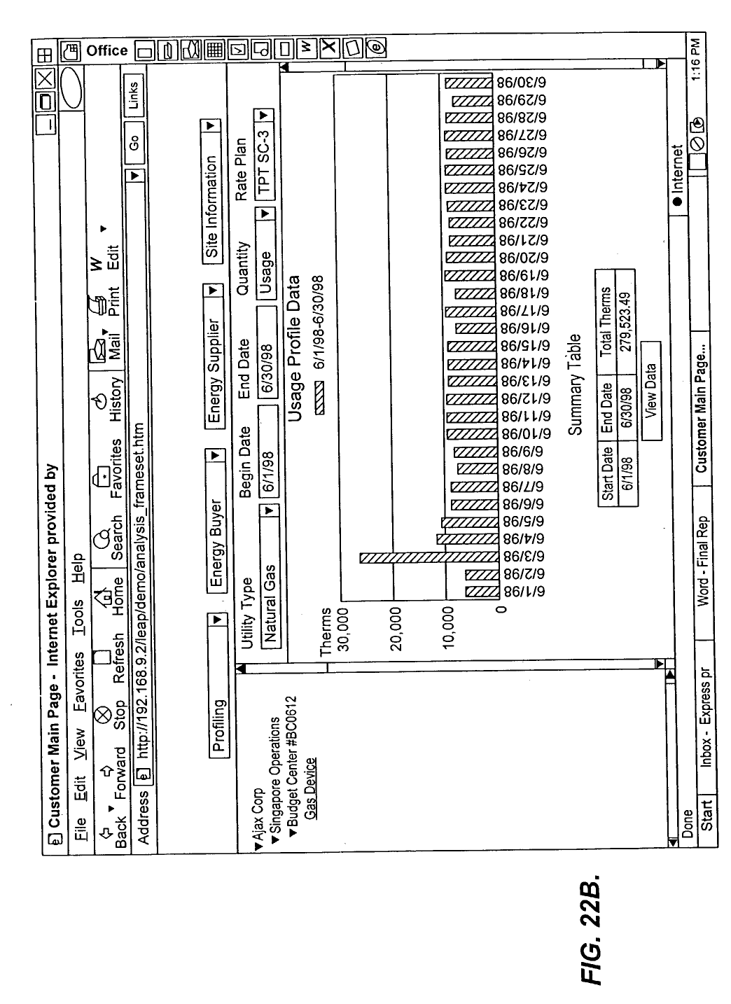

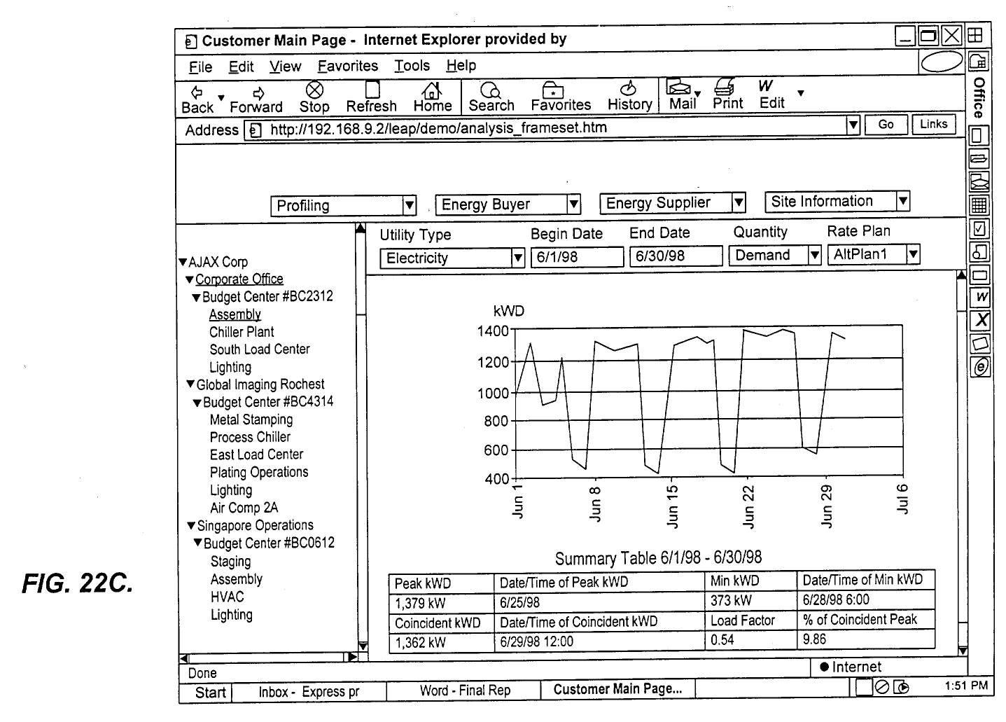

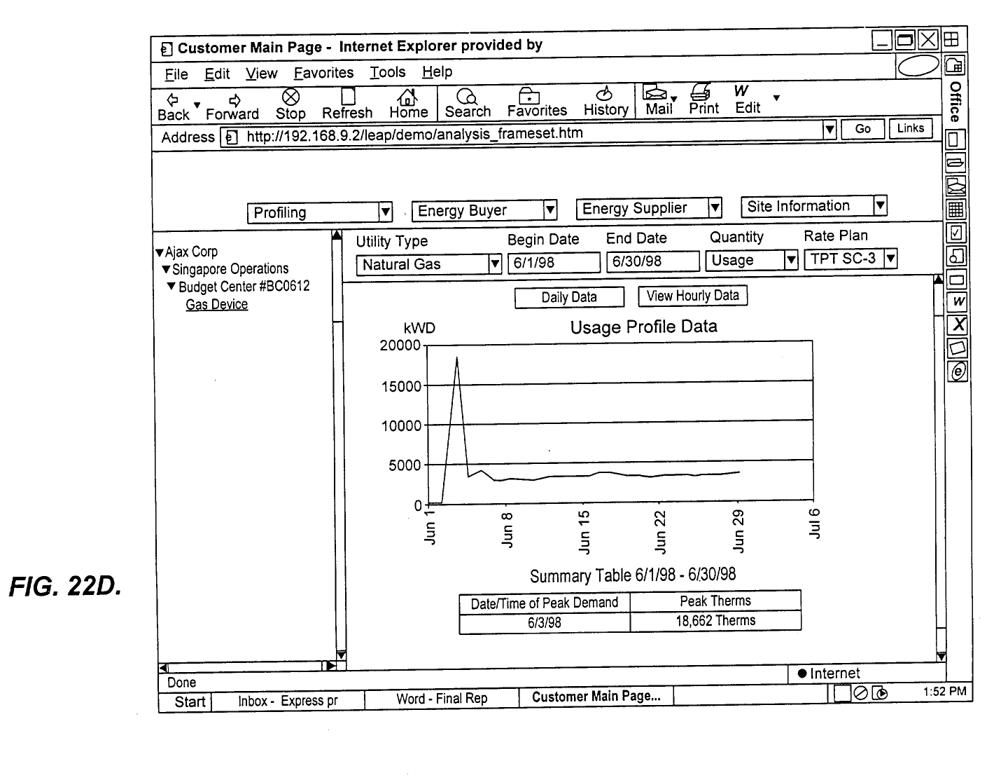

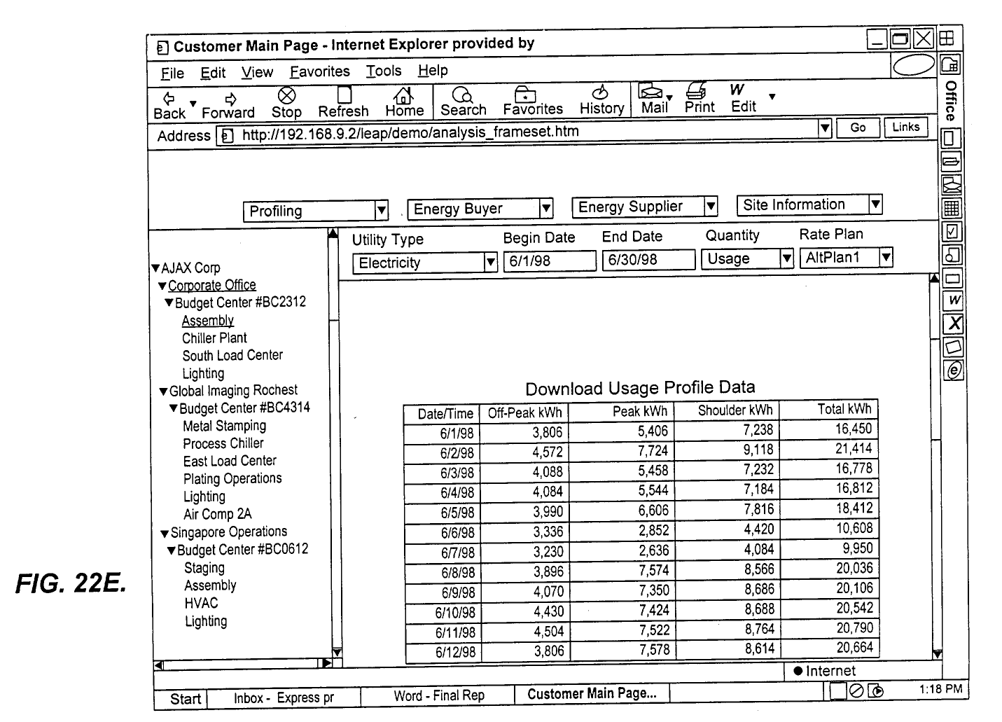

FIG. 22A shows window 550 including a main menu group 552 and sub-menu group 554. Additionally, location menu 556 and display area 558 are additional functional areas of the window.

Main menu group 552 includes four pull-down menus for setting the broad category of the display. For example, FIG. 22A shows that the broad category is for profiling energy buyer and energy supplier site information. Sub-menu group 554 refines the category of display to an electrical utility type for the indicated period of time. The “Usage” or consumption of electricity over the period of time is analyzed under the selected rate plan, “Alt Plan1”.

Within display area 558 are shown an electrical energy usage chart 560 and summary table 562. The chart and table are generated according to the selector and sub-menu menu selections. When the menu selections are changed, the information in display area 558, including the chart and table, are re-computed and updated, accordingly.

Location menu 556 allows selection of different entities. In the case of a corporate customer, or client, the entity divisions are by geography and corporate division, as shown. Any other breakdown or organization for entities can be used. The display area information is also geared to the location selection. For example, in FIG. 22A the chart and table are for electrical consumption for the Corporate Office's Budget Center #BC2312 Assembly division.

FIG. 22B illustrates another usage profile. Note that the sub-menu has been modified to select Natural Gas usage under a different rate plan. Although the rate plan selection does not affect the display of the chart and table shown in FIG. 22B, it is used in other displays where cost analysis is performed. A user can select their current rate plan or another rate plan for comparisons. FIG. 22B also shows, in the location menu, that a specific device in Ajax Corp. is being analyzed as to its natural gas usage. In a preferred embodiment, the user can select subdivisions within a company by designating a corporation, division and building within the company. A process or device consuming resources within the building can also be designated.

FIG. 22C shows an example of a demand chart for electricity for the indicated device during the indicated interval.

FIG. 22D shows an example of a demand chart for natural gas.

FIG. 22E shows more details of the table format for presenting information. The information in the display area of the interface, i.e., the charts and tables, can be downloaded for storage at the client's computer, inclusion in documents, spreadsheets, email, etc.

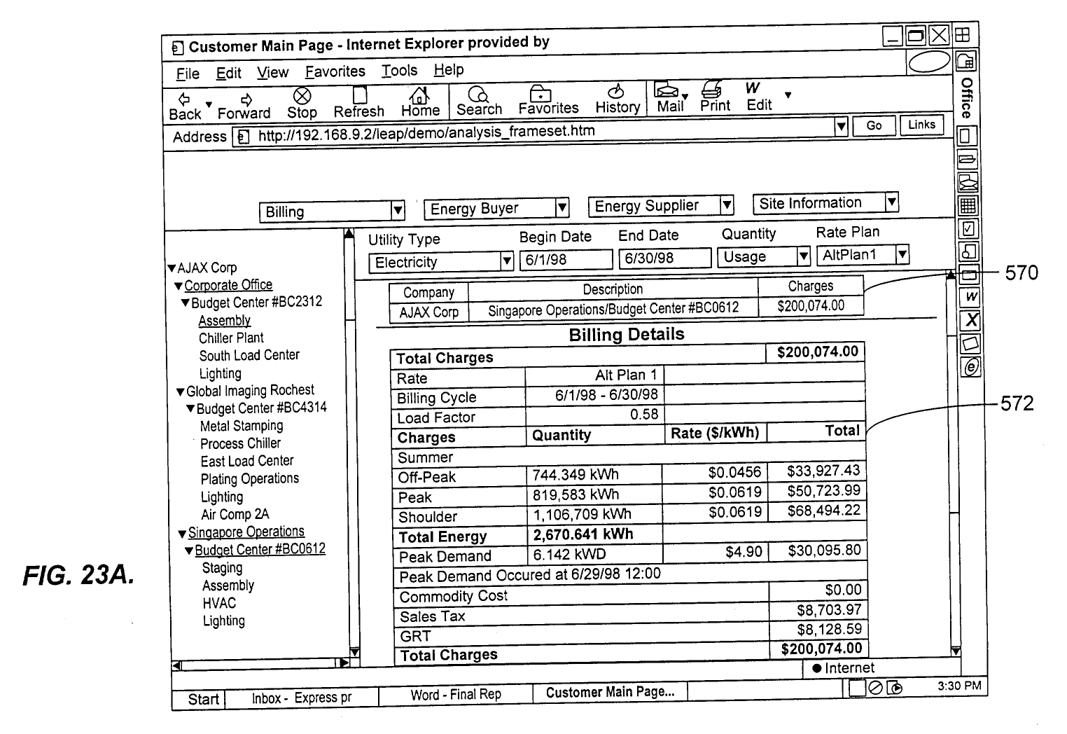

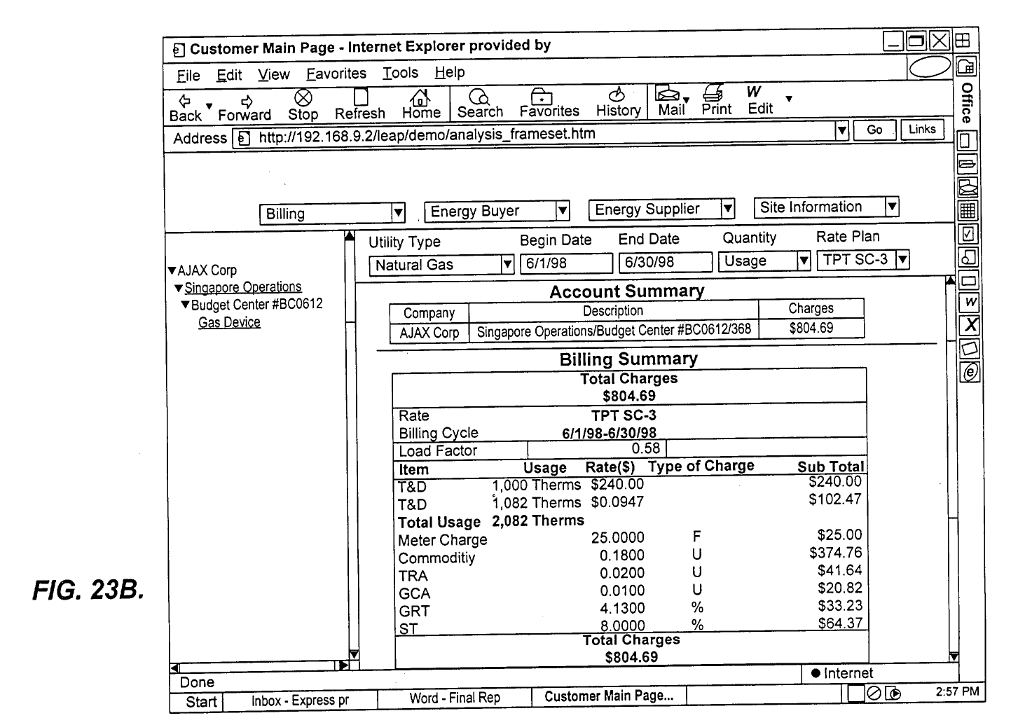

FIG. 23A shows billing information in the display area. Note that the main menu selector has been set to select “Billing” information. The location menu has been used to select (by the appropriate heading with a mouse pointing device) the “Singapore Operations/Budget Center #BC0612” division and building of “AJAX Corp”. In the display area, the Company and division description appear in a first table header 570 and the billing details appear in billing details table 572.

Note that the computations in the tables of FIG. 23A are based on the selected Rate Plan, “AltPlan1”. The user can check the predictions of using other rate plans by simply changing the selected rate plan in the Rate Plan pull-down menu.

FIG. 23B shows the natural gas consumption data for the period from Jun. 1, 1998 through Jun. 30, 1998 for a specific gas device designated as “368” under the rate plan “TPT SC-3”.

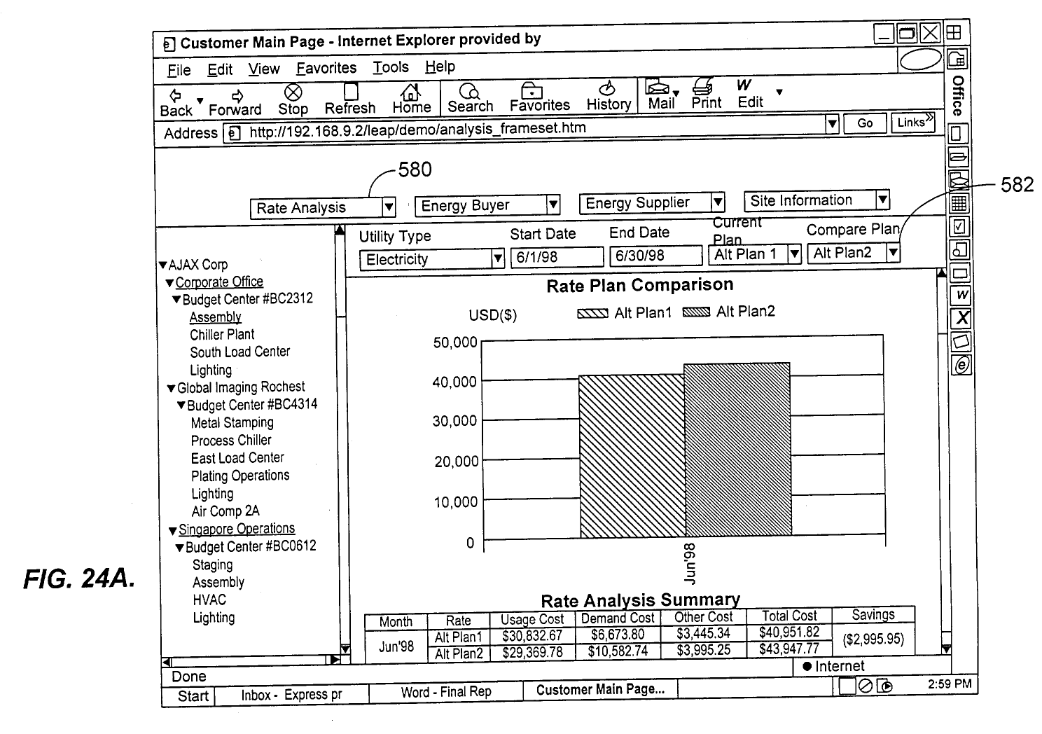

FIG. 24A illustrates the rate analysis feature of the present invention.

In FIG. 24A, the main menu shows that a rate analysis has been selected by the pull-down menu at 580. This provides an additional pull-down 582 menu in the sub-menu group so that two rate plans can be specified. The second rate plan specified in additional pull-down menu 582, called “AltPlan2,” is then compared to the first rate plan, “AltPlan1,” in bar graph and table form as shown in the display area of the user interface window of FIG. 24A. Thus, the rate analysis feature allows users to compare a current rate plan with one or more plans from competing suppliers. The system calculates differences between plans and displays potential savings or increased costs over the specified interval and for the location or device.

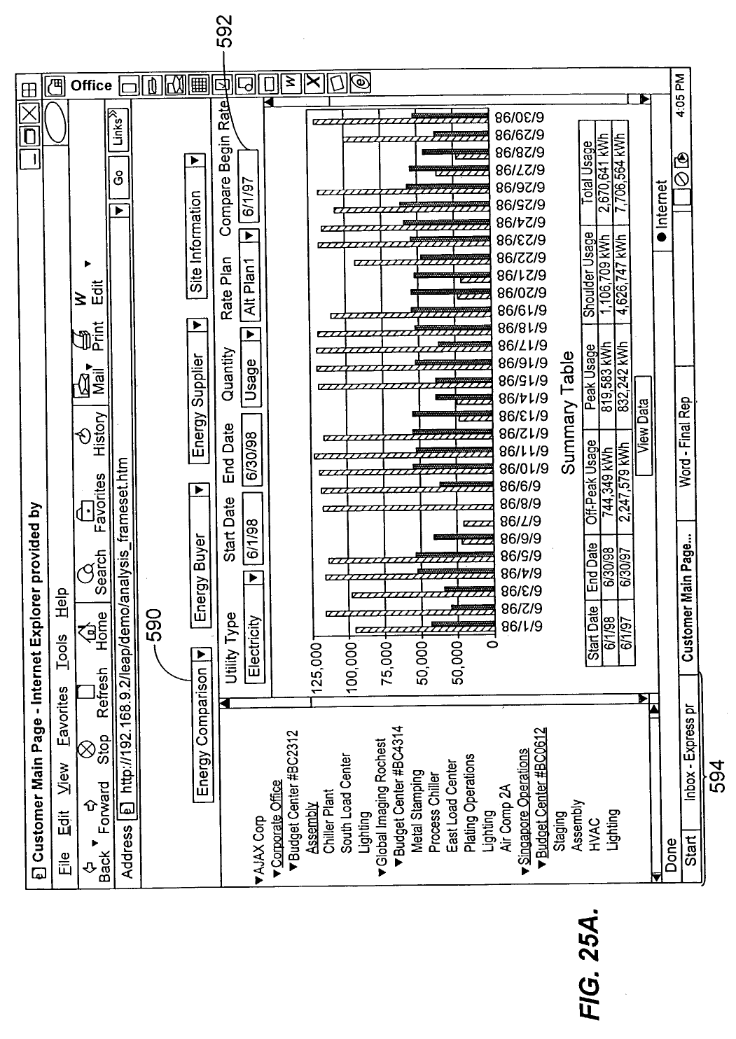

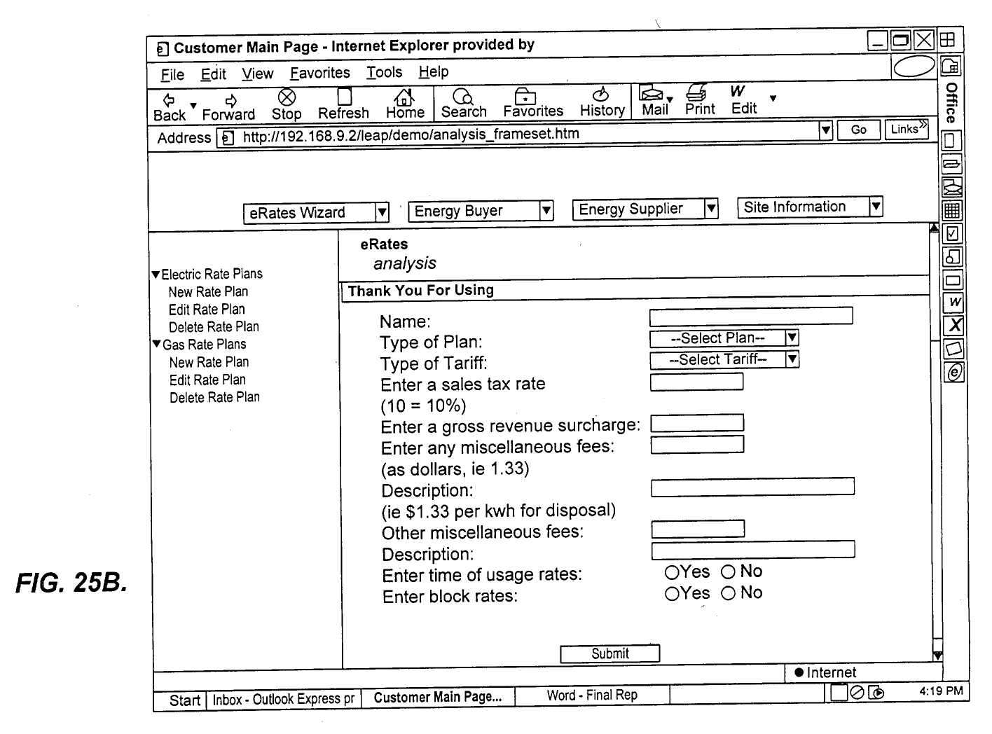

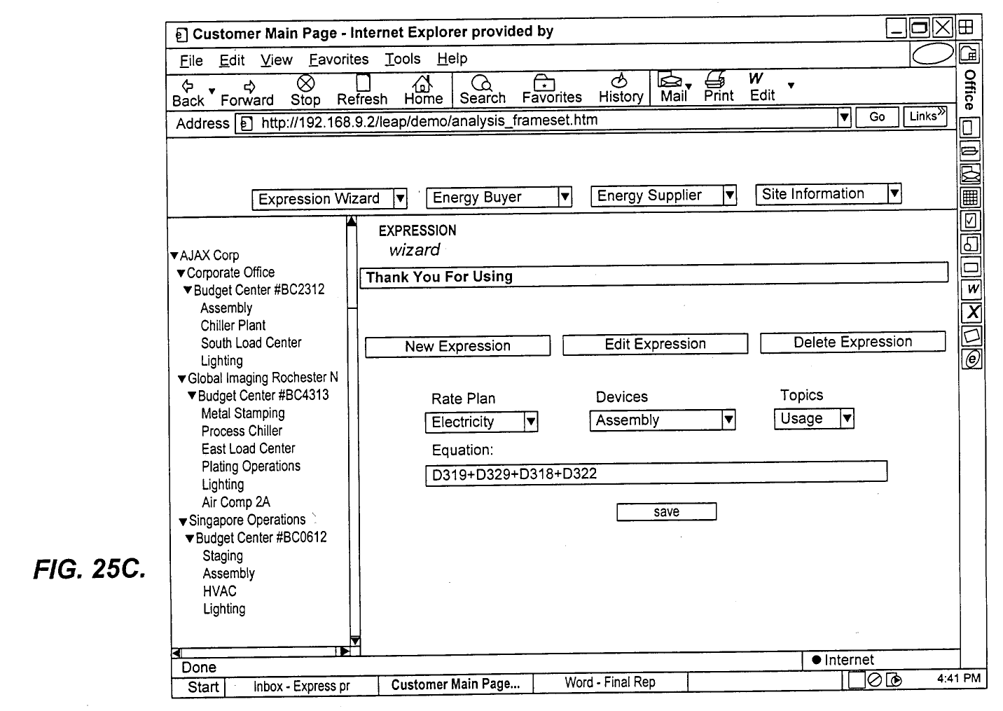

FIG. 25A shows the energy comparison feature of the present invention.

In FIG. 25A, the main menu has been used to select an “energy comparison” mode as shown at 590. This causes a “Compare Begin Date” field to appear in the sub-menu at 592. The user can enter in a starting date to compare energy usage between two different time periods. In the case shown in FIG. 25A, the base time period is from Jun. 1, 1998 through Jun. 30, 1998 while the compare date is from Jun. 1, 1997 through Jun. 30, 1997. The resulting bar graph and table are shown in the display area. The actual screen display makes use of color to show distinctions. Such colors may not be reproduced in the patent specification. In the preferred embodiment the base time period electrical energy usage is show as blue bars in the chart while the comparison time period of Jun. 1, 1997 through Jun. 30, 1997 is shown as a series of blue bars. The electricity usage is for the Budget Center #BC0612 area, as before.

Note that once the main and sub menu selections have been made, the comparison over the same intervals can easily be applied to different locations. All the user needs to do is click on a menu selection in the location menu sidebar at 594 to designate a different company division, building, site, process or device. Once the location selection has been made, the information in the display area is updated to reflect the data for the location. The summary table below the graph summarizes energy comparison information and displays the difference in usage over the time period selected. “View Data” button 596 is used to display a table with the raw data that is used to generate the comparison profile. Users can also download the data into spreadsheet, or other, format for further analysis.

FIG. 25B illustrates a rate plan creation feature of the present invention.

In FIG. 25B, an “eRates wizard” user interface is selected by a user via the main menu selectors. The wizard interface allows a user to define and name a customized rate plan to be used for resource analysis and billing. The user can define a simple or complex rate plan for both retail access and standard tariffs. The sidebar menu selections allow for creating, editing and deleting rate plans. As shown in FIG. 25B, a basic plan can be selected with provisions for specifying several parameters of the plan such as sales tax, gross revenue surcharge, etc.

FIG. 25C illustrates the expression wizard which is used to define a meter hierarchy that may exist within an organization or across an organization allowing users to define mathematical expressions that represent billing, allocations and energy usage. Once an equation has been defined or edited, the site map is dynamically updated to reflect the new roll-up.

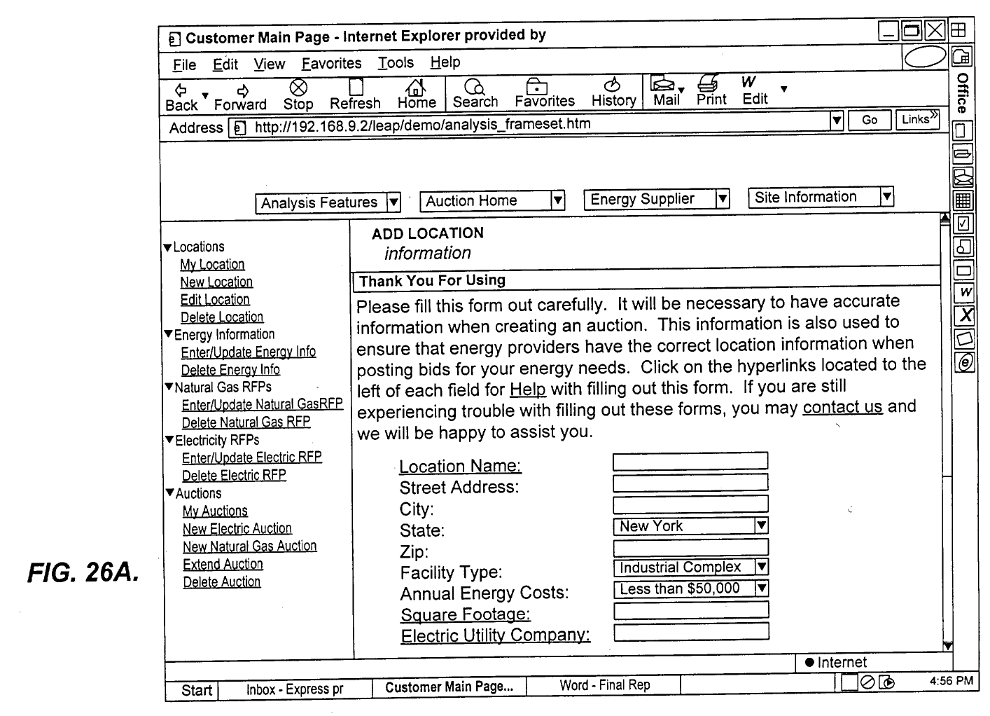

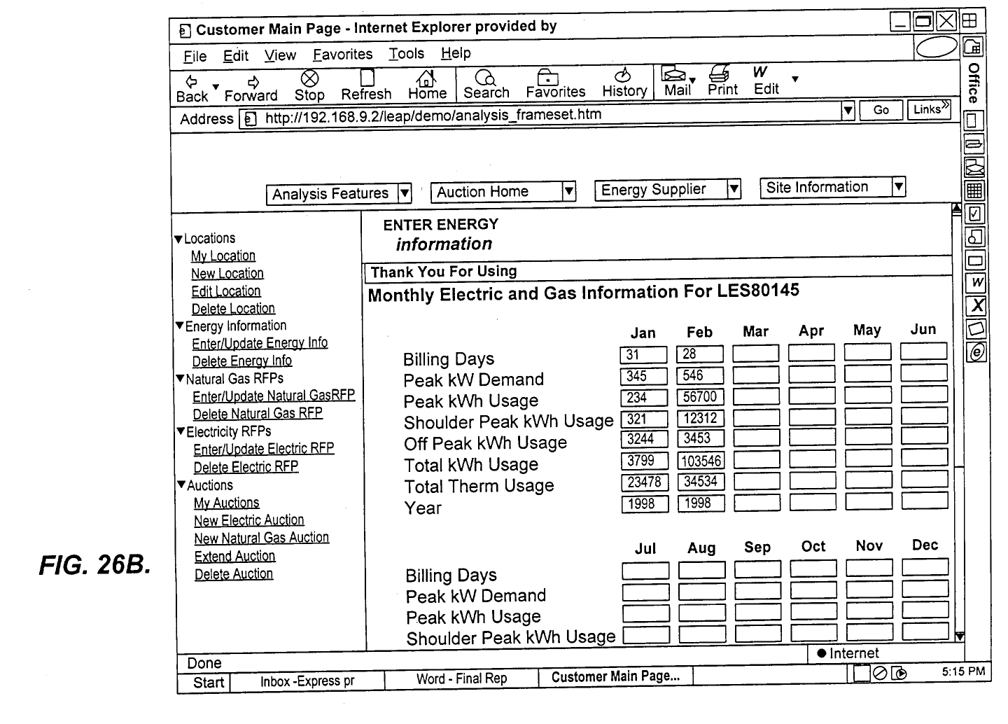

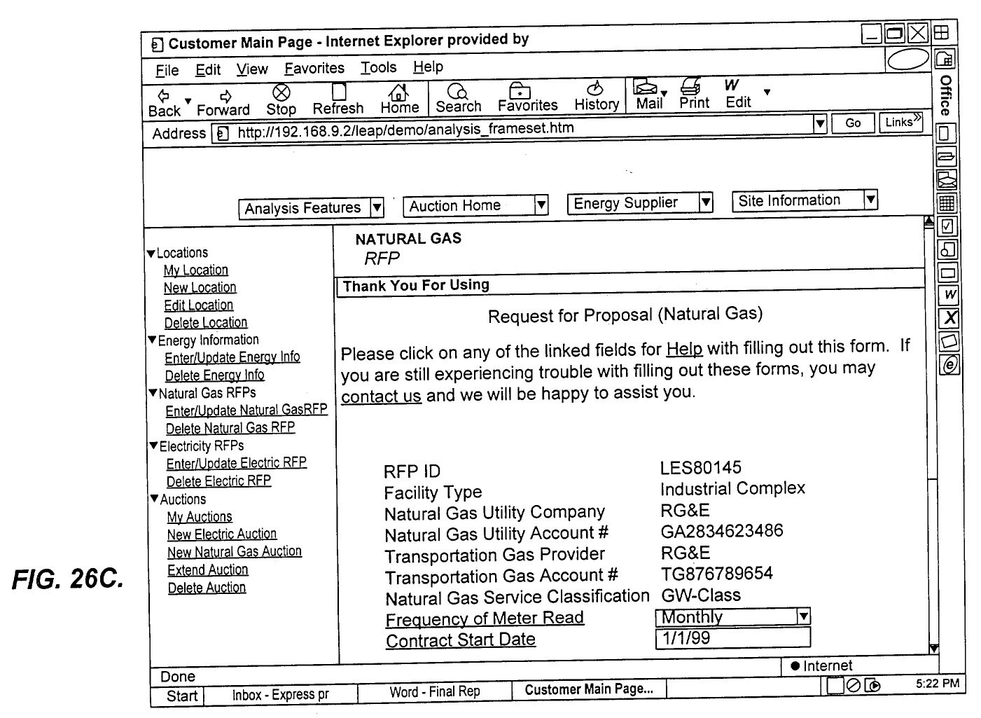

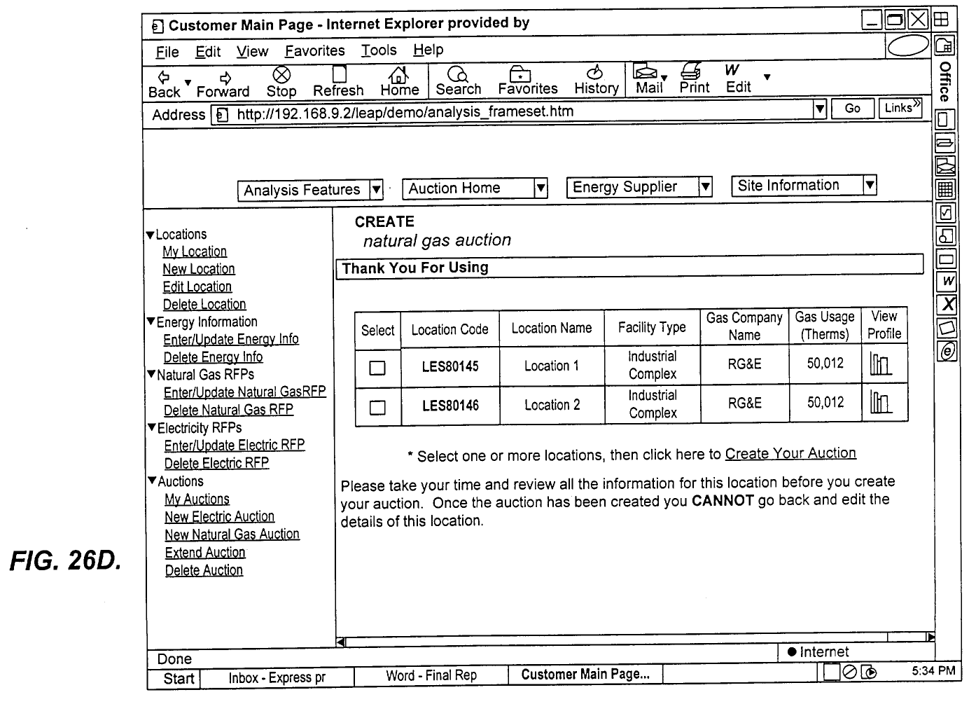

FIGS. 26A-D illustrate screen interfaces for four basic steps performed by a user who desires to buy energy to create an auction for bids of energy suppliers.

FIG. 26A shows a user interface screen allowing a user to define the user's geographic location information. Location information includes service territory, rate and service classification for both natural gas and electricity, facility type, annual energy costs, etc. Note that hyperlinks for headings such as “Location Name,” “Square Footage,” and “Electric Utility Company” are used to provide helpful information or selections for the associated topics. For example, the “Location Name” hyperlink can bring up a text list, or map image, of possible zones, or areas, for auctions. This is useful to give the company administering the user interface web site (e.g., Logical Energy Solutions, Inc.) control over the geographic focus of the auctions. The “Square Footage” hyperlink can bring up a calculator, table, or other way to estimate the square footage.

FIG. 26B shows a screen of the user interface that accepts energy usage information from the user. In a preferred embodiment, users must enter in a minimum of 3-months of energy usage information. For users that have metered information dynamically logging to the system (e.g., automated data gathering, as described above in reference to the Jini technology), this step is unnecessary. Manual data entry allows users that do not currently have metered information to manually input information from utility bills and participate in an energy auction.

FIG. 26C allows the user to specify basic terms for the auction. The user must define the terms and conditions for an electric and/or natural gas auction of which an energy provider must agree to before submitting a bid. The information that is gathered in this Request for Proposal (RFP) allows a bidder to price energy commodity according to the buyer's terms and conditions. If a user has more detailed terms and conditions that are defined in a word processing document it can be attached and uploaded to the system for energy suppliers to download and view.

FIG. 26D allows the user to post the auction to one or more locations. The final step in the auction process is for the user to select one or multiple locations to post to the auction. From this screen the user can select and aggregate multiple locations within the same service territory or across service territories for the purposes of aggregate purchasing. The user can also click on the view profile icon to display a profile of their energy usage. This is the same profile that suppliers will view when positing a bid. Once the user has selected the location or group, the user then clicks on the “Create Auction” link.

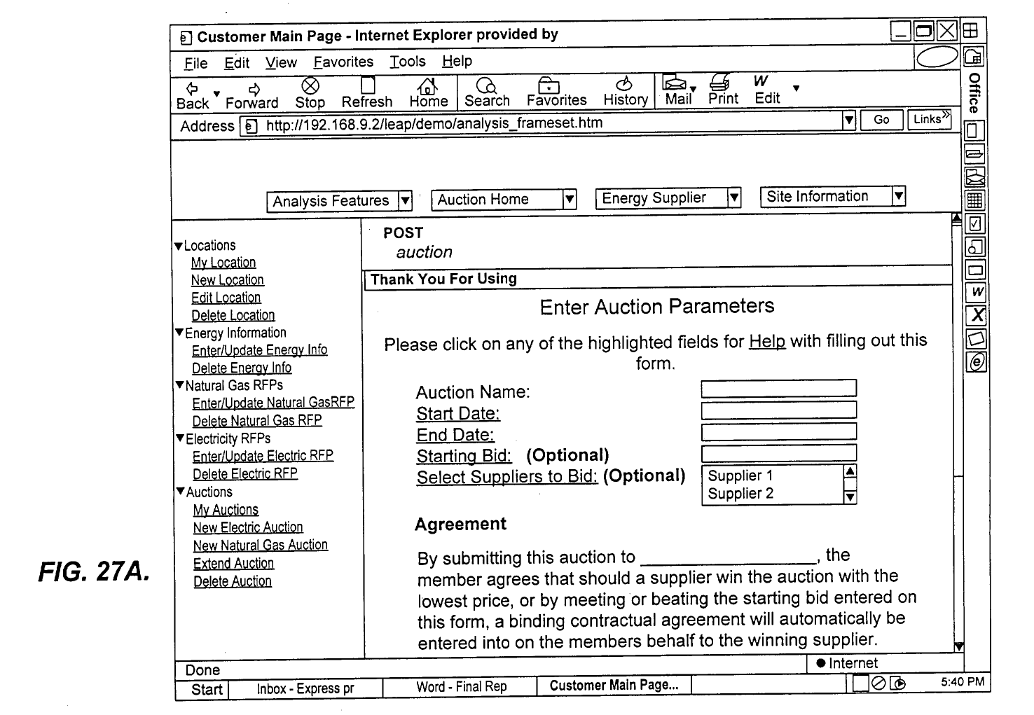

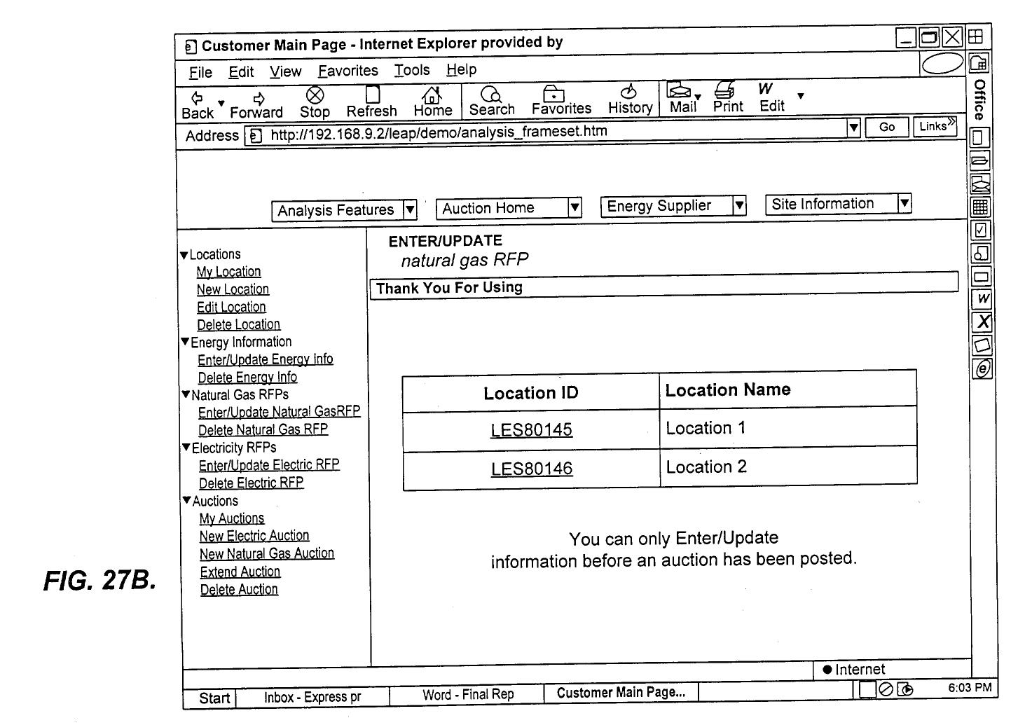

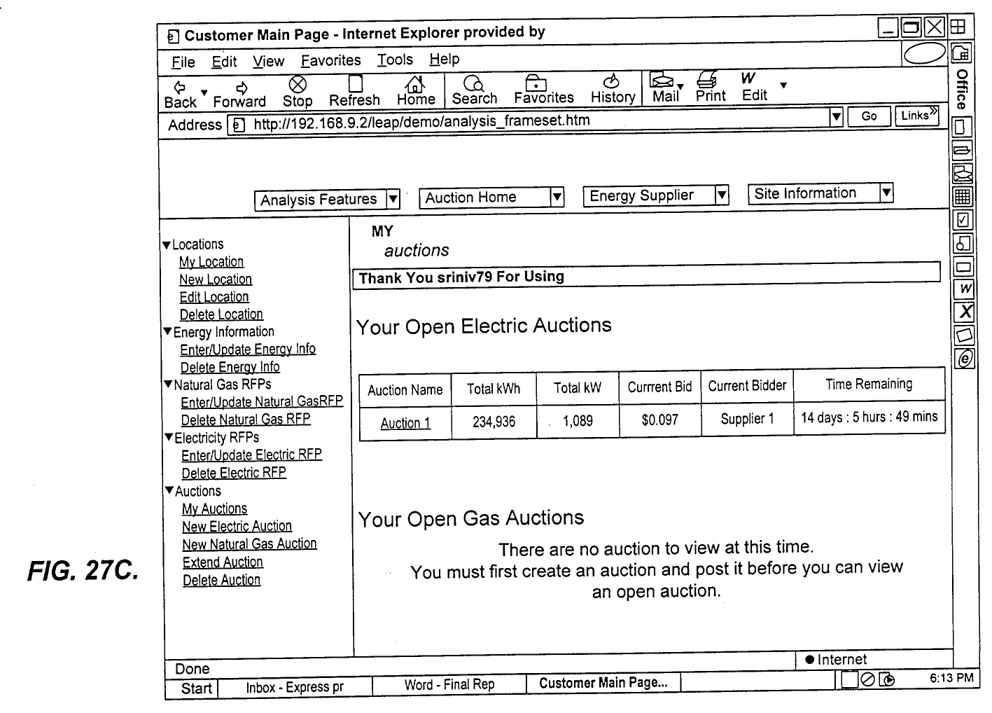

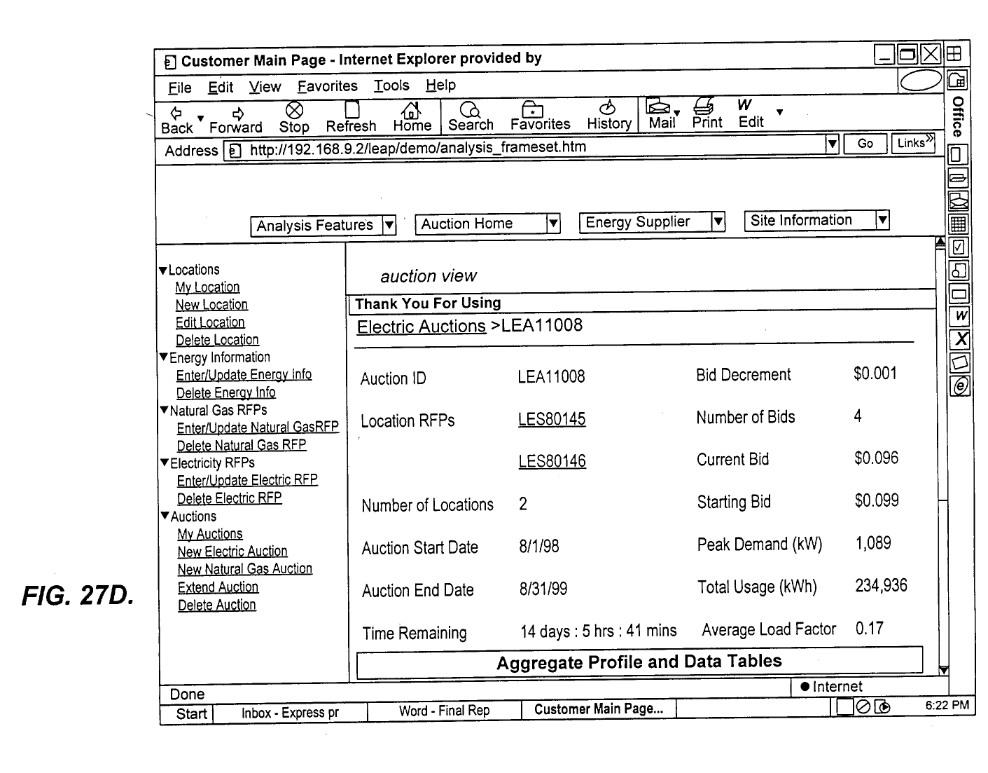

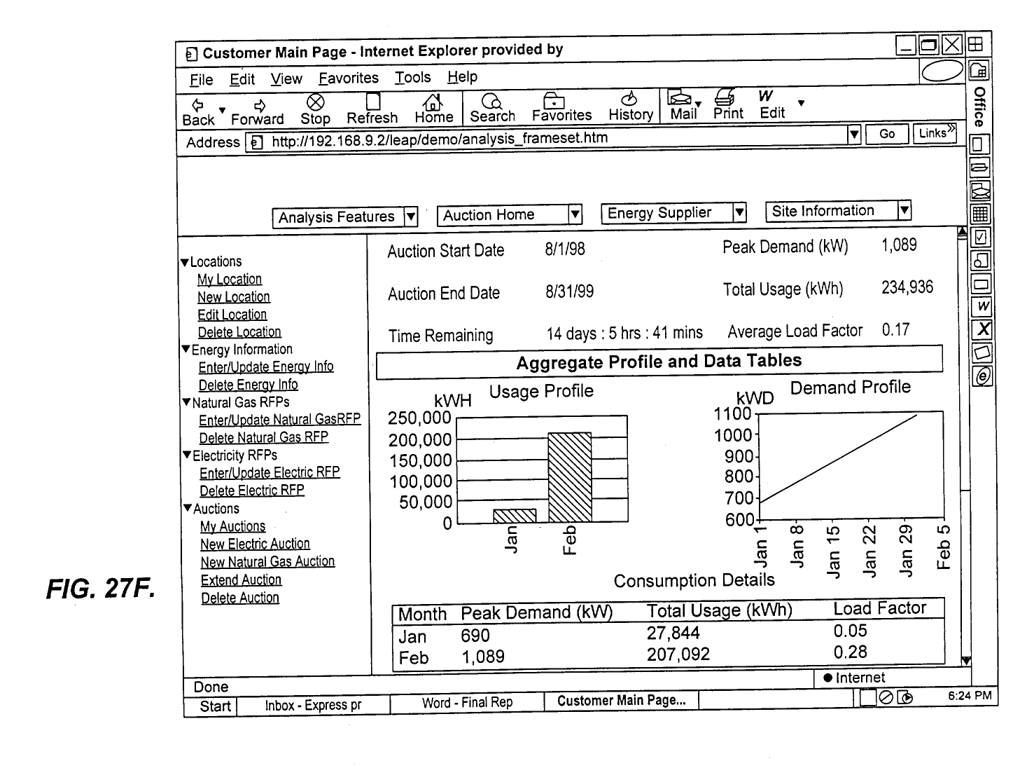

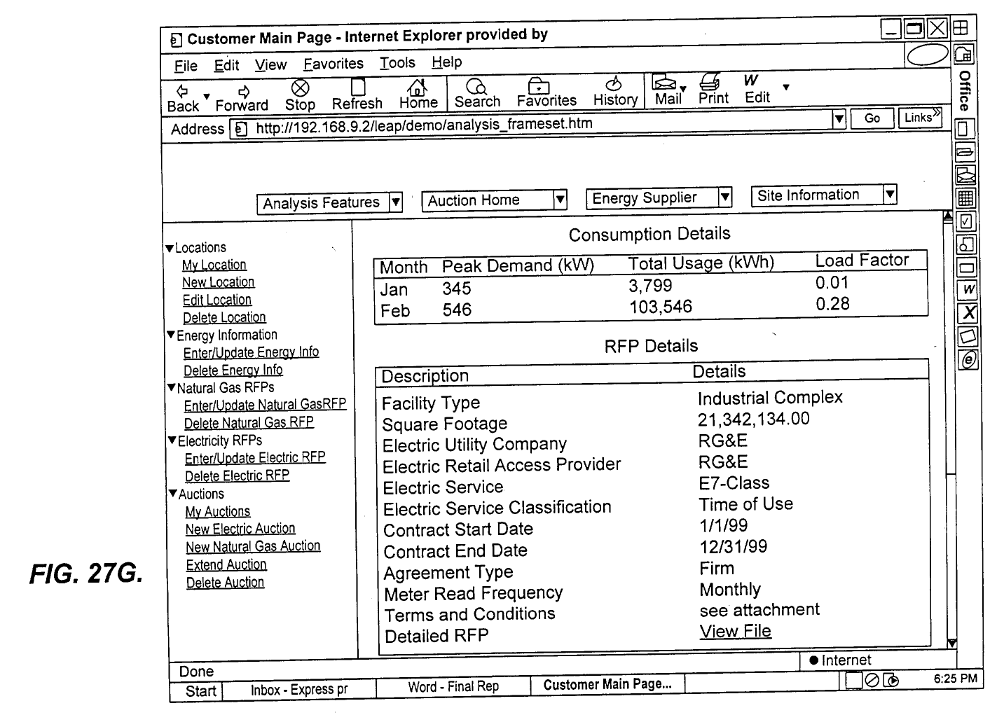

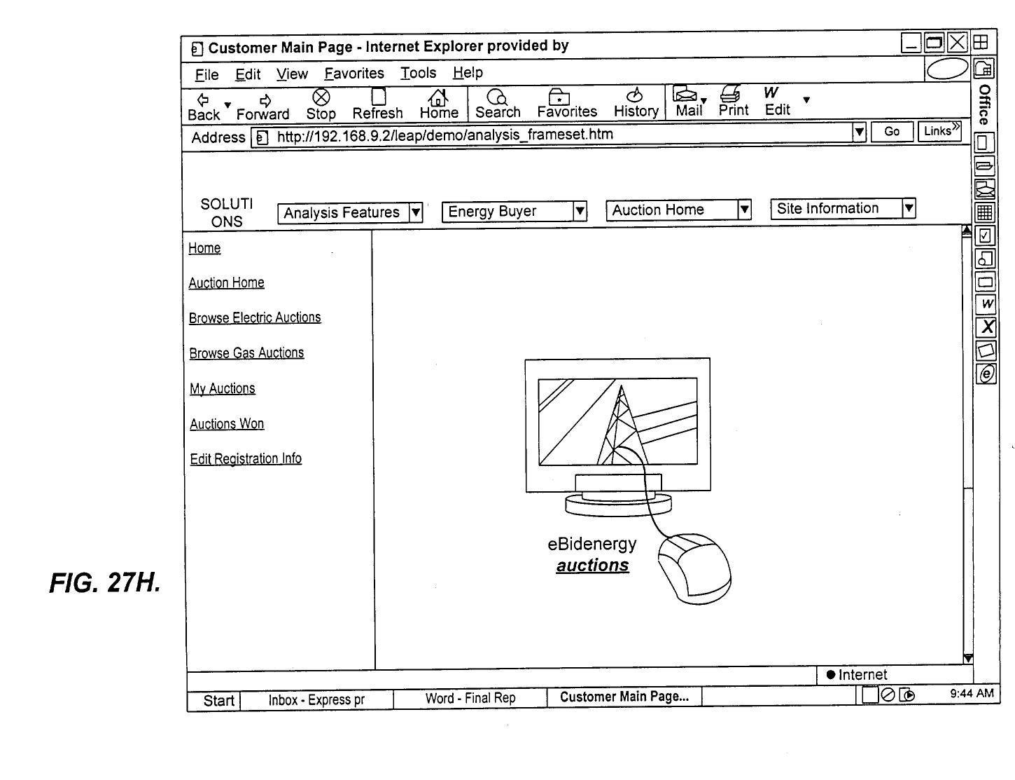

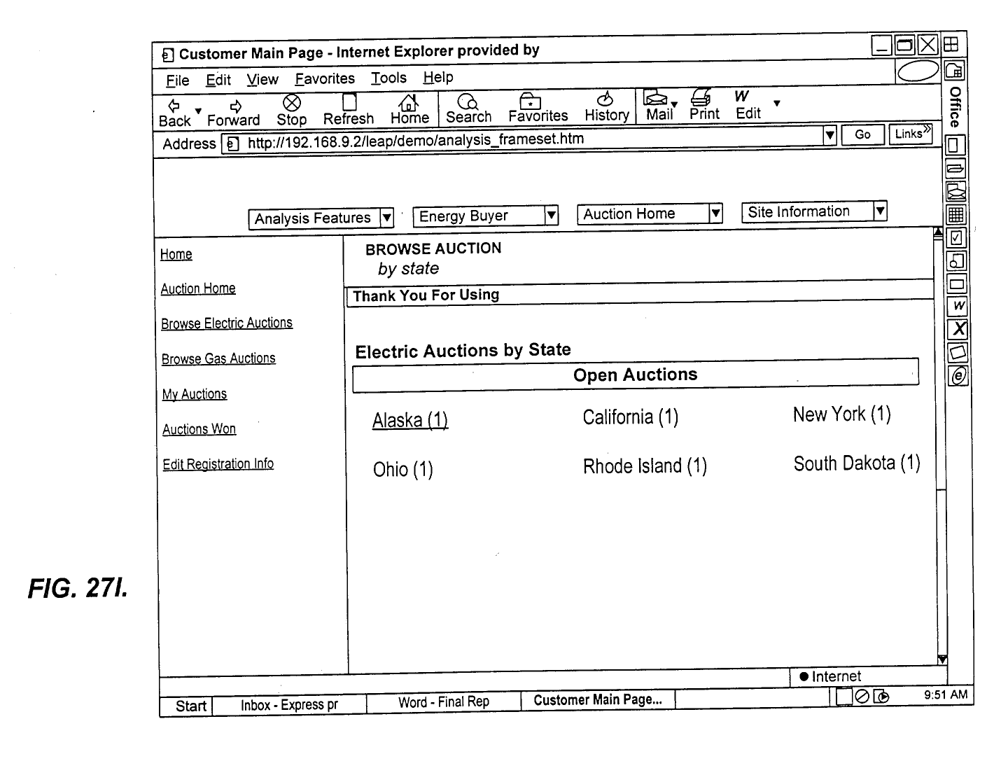

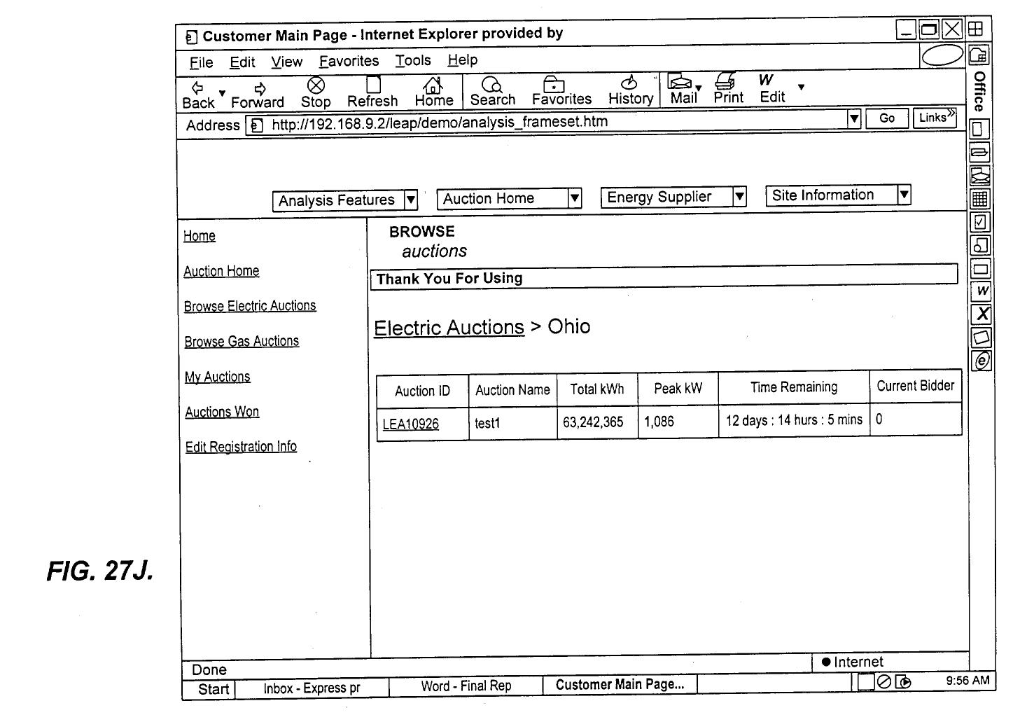

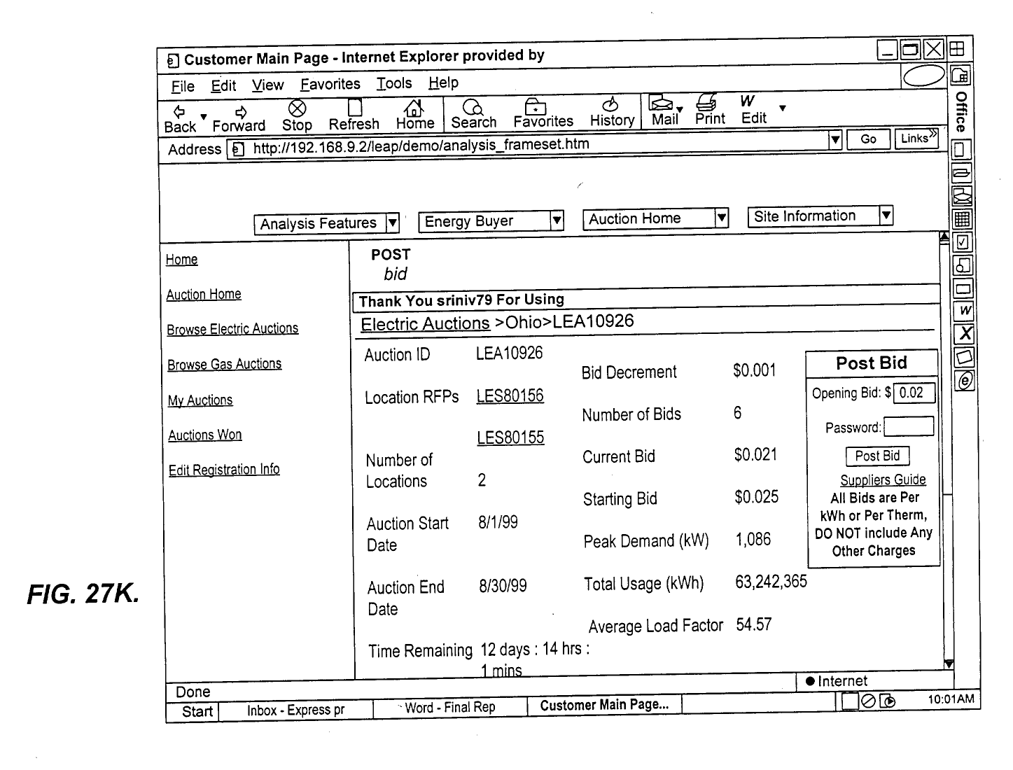

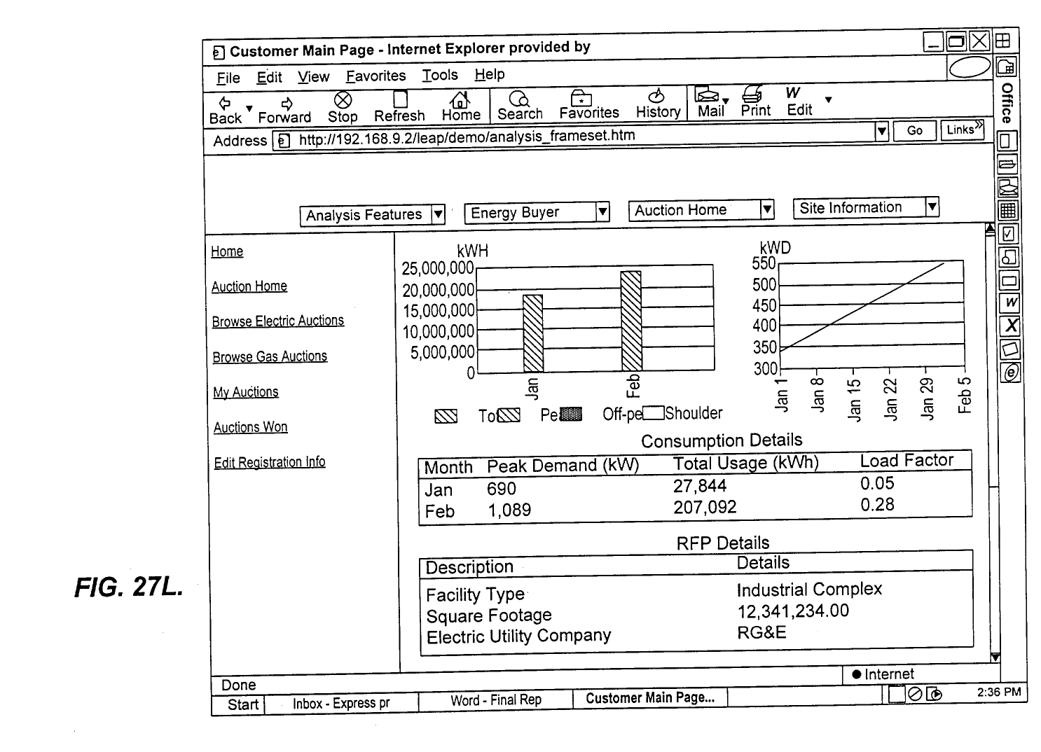

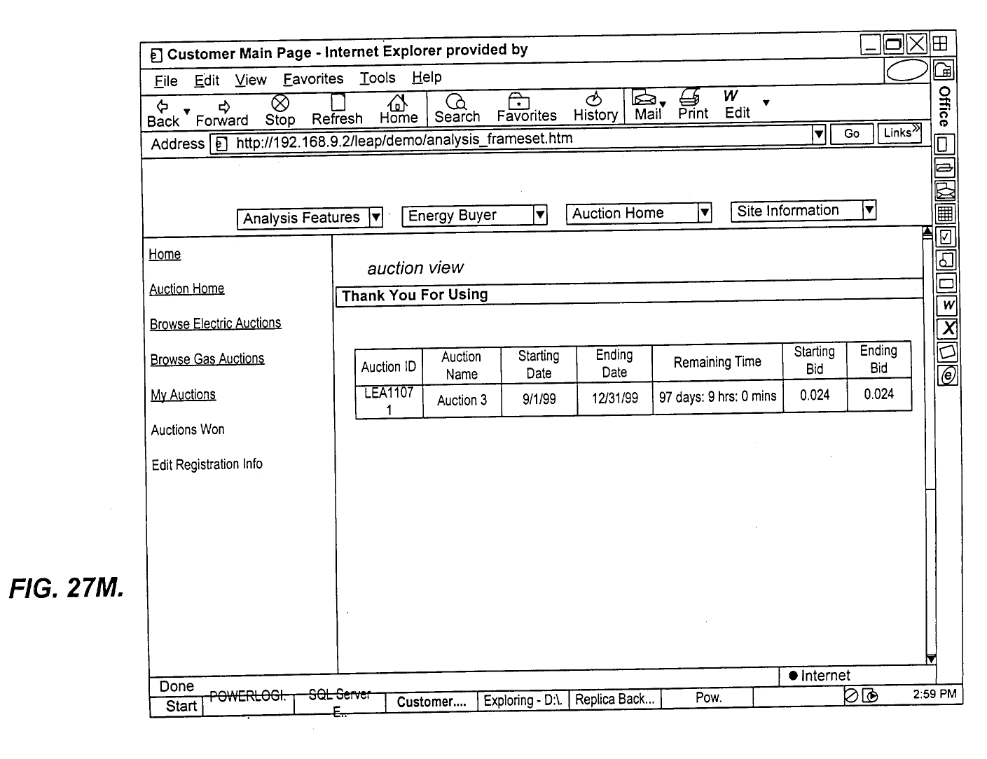

FIGS. 27A shows the final information requested of the user to create the auction. The user clicks on the “Create Auction” link and defines the auction name, start date and end date of the auction. Some of the more advanced energy users will have already received bids from alternate suppliers and may want to post a stating bid which is at or below the bid they received via traditional means. This option ensures the user that the bidding will start at or below the starting bid. If the buyer does not use this field, the first supplier to post a bid would then set the starting bid. Users can also define the suppliers that will be notified via email of the upcoming auction. If the buyer does not use this field, all suppliers will be notified of the open auction. Before the auction is submitted, users must agree to a binding contractual agreement with the lower bidder. Users have the opportunity to edit and/or delete auction information if there have been no bids posted on their auction.

The Figs., below, show additional aspects of the invention as follows:

In FIG. 27B users have the ability before an auction has been posted, to update or edit all information used to define their auction, (i.e., location information, energy information and RFP information).

In FIG. 27C users can view a summary of their open auctions which provides surface level usage and bid information. If a more detailed summary of the auction is desired a user can click on the hyperlink and view a more detailed summary of the auction.

In FIG. 27D the eBidenergy auction view allows the user to view a more detailed summary of the auction activity (i.e., number of bids, current bid, starting bid, auction start and end dates, etc.). If the user has aggregated multiple locations, they will have the opportunity to disaggregate by selecting the location RFP's and profile information for each location.

In FIG. 27E users can also view aggregate usage statistics related to the specific locations posted to auction.

In FIG. 27F users can also view aggregate usage statistics related tot he specific locations posted to the auction.

In FIG. 27G users can also view their RFP information for each of the locations. If the user has attached an RFP, they can select the view file hyperlink and download the RFP.

In FIG. 27H energy providers will login to their main splash page as shown above. The main splash page has all the navigation required to return to eBidenergy.com home, or review open auctions for electric and natural gas. The following screenshots will outline the process an energy provider will go through to submit a bid on a buyer's energy needs.

In FIG. 27I, energy suppliers may browse electric or natural gas auctions by State. Suppliers may select any states that they are approved in and view the list of auctions in that state.

In FIG. 27J, once the supplier has selected the state they wish to do business in, a list of auctions will appear. The supplier will then get a brief summary of the buyers usage, time remaining on the auction and current bid. If the supplier is interested in posting a bid, or viewing a more detailed summary of the buyer's requirements, they will click on the hyperlink under auction ID.

In FIG. 27K, once the supplier has clicked on the hyperlink under auction ID, specific details of the auction will appear. The supplier can then either post a bid on the auction, or click on the hyperlinks to locate specific RFP's to view specific requirements of the group or the individual buyer.

In FIG. 27L, in the post bid form, a supplier can view a customer's usage and demand profile and a summary of energy usage. Details of the customers RFP are also made available for the supplier to view or download if a buyer has attached a detailed RFP.

In FIG. 27M, suppliers can click on the hyperlink located on the main navigation bar and view all the auctions that they have posted a bid on. The page will provide a summary of the auctions currently in progress as well as the auctions that have recently closed. In addition to the status of the current auctions, suppliers can view the starting bid and the auctions ending bid.

Although the present invention has been discussed with respect to specific embodiments, these embodiments are merely illustrative, and not restrictive, of the invention. For example, although the invention has been presented in terns of allowing energy buyers to create auctions for obtaining energy supplier bids, the reverse is possible whereby energy suppliers allow bids from energy buyers. In general, any commerce scheme for matching an energy, or other resource, buyer to a supplier is adaptable for use with the present invention. Thus, the scope of the invention is to be determined solely by the appended claims.

What is claimed is:

1. A user interface for facilitating the sale of resources over a digital network, the user interface including one or more instructions executed by one or more processors coupled to a user input device and a display device used by a human user, the user interface comprising
one or more instructions for displaying information on the display device to prompt the user to specify resource consumption needs;
one or more instructions for accepting signals from the user input device to specify resource consumption needs; and
one or more instructions for transferring the specified resource consumption needs to a process for identifying one or more resource suppliers to satisfy at least a portion of the specified resource consumption needs.

2. The user interface of claim 1, wherein the one or more instructions for displaying information include
one or more instructions for displaying statistics on resource consumption.

3. The user interface of claim 2, wherein the displayed statistics include statistics on projected resource consumption.

4. The user interface of claim 1, further comprising
one or more instructions for accepting signals from the user input device to specify a predetermined rate plan for resource consumption.

5. The user interface of claim 4, further comprising
one or more instructions for modeling resource consumption using the specified predetermined rate plan; and
one or more instructions for displaying the results of modeling resource consumption.

6. The user interface of claim 1, further comprising
one or more instructions for allowing the user to define an expression including a resource consumption indicator.

7. The user interface of claim 1, wherein the process for identifying uses an auction to identify a resource supplier.

8. The user interface of claim 1, wherein the resource is energy.

9. The user interface of claim 1, wherein the resource is electricity.

10. The user interface of claim 1, wherein the resource is gas.

11. A user interface for creating an auction for accepting bids from resource suppliers to supply a resource buyer, the user interface including one or more instructions executed by one or more processors coupled to a user input device and a display device used by a human user, the user interface comprising
one or more instructions for displaying information on the display device to prompt the user to specify resource consumption needs;
one or more instructions for accepting signals from the user input device to specify resource consumption needs;
one or more instructions for accepting signals from the user input device to define one or more terms for the supply of the resource; and
one or more instructions for transferring the specified resource consumption needs to a process for identifying one or more resource suppliers to satisfy at least a portion of the specified resource consumption needs.

12. The user interface of claim 11, further comprising
one or more instructions allowing the user to select at least one location to which to post the auction.

13. The user interface of claim 11, further comprising
one or more instructions allowing the user to view the status of one or more open auctions.

14. A computer-readable media including the instructions of claim 1.

15. A computer-readable media including the instructions of claim 11.

16. A method for facilitating the sale of resources over a digital network, the method including instructions executed by one or more processors coupled to a user input device and a display device used by a human user, the method comprising
displaying information on the display device to prompt the user to specify resource consumption needs;
accepting signals from the user input device to specify resource consumption needs; and
transferring the specified resource consumption needs to a process for identifying one or more resource suppliers to satisfy at least a portion of the specified resource consumption needs.
